(19) United States
(12) Patent Application Publication
(10) Pub. No.: US 2013/0090968 A1
(43) Pub. Date: Apr. 11, 2013

(54) METHODS OF EMPLOYEE SCHEDULING AND MANAGEMENT

(71) Applicant: Stephen Borza, Ottawa (CA)

(72) Inventor: Stephen Borza, Ottawa (CA)

(21) Appl. No.: 13/646,836

(22) Filed: Oct. 8, 2012

Related U.S. Application Data
(60) Provisional application No. 61/545,764, filed on Oct. 11, 2011.

(51) Int. Cl. G06Q 10/06

(52) U.S. Cl. 705/7.16

(57) ABSTRACT

Organizations must manage employee schedules to ensure that adequate personnel are present as required, regulatory requirements met, and costs tracked/minimized. Prior art systems are taught as internal to an organization and hence do not address part-time or temporary employees who have multiple conflicts on their time. An employee scheduling software system is taught that accesses multiple extrinsic databases hosting schedules relating to an employee allowing scheduling to avoid external conflicts for the employer and allowing employees to respond to schedules as well as trade/auction with other employees with confidence. Further, by associating a portable electronic device to the employee and hosting a scheduling application on these devices the employees are able to review/modify/trade/auction shifts with increased flexibility and employers are provided with a more accurate clocking in/out process to verify the employee's attendance and completion of their shift.

### CROSS-REFERENCE TO RELATED APPLICATIONS

This patent application claims the benefit of U.S. Provisional Patent Application 61/545,764 filed Oct. 11, 2011 entitled “Methods of Employee Scheduling and Management” the entire contents of which are incorporated herein by reference.

### FIELD OF THE INVENTION

This invention relates to computer systems for employee scheduling and more particularly to a computer system providing enhanced interfaces and information management.

### BACKGROUND OF THE INVENTION

As soon as an organization has people associated with it, be they owners, employees, volunteers, etc then there exists the issue of managing their schedules to ensure that, amongst other issues, adequate personnel are present when the organization requires them, that holidays can be accommodated, sick days managed, and costs tracked or minimized. Additionally organizations must ensure that they comply with local, state, and Federal laws that define many aspects of an organizations labour policies including for example maximum hours working continuously, break durations, and total hours per day.

These problems are exacerbated when the hours of operation for the organization are outside what are commonly referred to as “office hours” that are normally considered to be 9 am to 5 pm. Organizations such as banks, dentists, doctors etc are typically open earlier and later than this in order to provide flexibility for office workers, students, etc. Manufacturing organizations are typically open for extended periods to maximize utilization of expensive manufacturing equipment, facilities etc. Within manufacturing organizations “shift work” is the employment practice designed to extend manufacturing from 8 hours a day to 12, 16, and even 24 hours a day. Further many manufacturing organizations extend beyond the so-called “work week” of Monday-Friday and operate seven days a week leading to concepts such as 24/7 (24 hours a day/7 days a week) and 365/24/7 (365 days a year/24 hours a days/7 days a week).

Accordingly the term of “shift” has become a common term to reflect a period of time that an employee works where multiple “shifts” for multiple employees combine to provide the right personnel mix over the period of time the organization is open. Shifts can include short shifts of a few hours through to extended night shifts, 12 hours shifts and be based upon work schedules in which employees change or rotate shifts or are scheduled based upon multiple factors.

Over time many different shift patterns have been established to try and address the requirements of organizations to provide extended hours of operation whilst faced with limited hours per employee, for example with students and part-time employees whose time is balanced between work and other activities, or statutory limits for full-time employees. These include the three-shift system; four on, four off; Navy Three-shift underway system; four on, three off; four on, two off; four on, one off; two days, two nights, four off; 5/4/9's; 12/24/12/48; continental shift; split shift; earlies and lates; 7-day fortnight shift; DuPont 12-Hour rotating shift; five and two; seven-day eight-hour rotating shift; sixes; firefighting schedules; California roll shift schedule; and four-platoon 24-hour shift schedule.

There are many known employee and workforce management systems used for scheduling and managing personnel but typically these are designed to support large organizations such as automobile assembly plants and telephone call centers. Such systems typically include a basic planning capability to enable a manager to forecast future workloads and employee requirements to service such loads. Some of these systems provide a scheduling capability which allocates employee work hours according to forecasted staffing requirements and employees are assigned to fill these schedules and their assignments are posted. The forecasting techniques employed in these systems are computationally-efficient, accurate on a macro scale, e.g., month-to-month, and to a limited degree, able to accommodate real-time changes over a more dynamic period, e.g., every hour.

Accordingly large employers utilizing these computerized scheduling software systems assign workers to different work shifts during a future wage period. The resultant work schedule is printed and provided to each employee prior to the wage period, thus informing the employee when to report for work and the duration of each work period. In many businesses, an employee's 7 work schedule varies from day to day and week to week. In a hospital for example, an employee may work eight hours during each of five consecutive days during one week, and then may work three twelve hour days the following week. Certain employees may be part-time, in which case they work less than an eight hour day. In addition, some employees are not assigned to a specific department, but float wherever workers are needed on a given day and these floating employees often work varying amounts of time depending upon the quantity of work being done.

Labour wage and employment laws restrict the number of hours that certain classes of employees may work during given time periods or the work they may perform. In other cases, when a defined number of hours have been worked during a specified time period, the employee must receive a higher level of compensation for additional work hours in that period. Failure to abide by these laws can result in the government assessing stiff penalties against the employer.

When it is known ahead of time that an employee will be absent, due to vacation, a planned medical treatment or the like, that employee is removed from the pool of people who may be scheduled to work during that period of time. Therefore, an automated scheduling program fills the work shift positions with only the available employees from that pool. However, a replacement worker may not be readily available from the group of employees that normally work a given job or in a particular department. In that situation a replacement worker may be found from another source, such as another department, another location, or from a temporary employment agency. Accordingly, prior art automated scheduling software systems accommodate searching predetermined partners for an available employee or supervisor.

K. O'Brien in U.S. Pat. No. 6,587,831 entitled “System and Method for Online Scheduling and Shift Management” discloses a system for centrally creating a schedule for a group of company employees who are geographically dispersed. Operating over a distributed network the system provides communications among employees and other data sources, such as an external employee provider. The system assigns the employees to shifts while accommodating numerous factors including staffing requirements, employee preferences, and settings based on forecasting. O'Brien teaches to forecasts exploiting factors outside the company that relate to weather and traffic. However, O'Brien and others in the prior art do not consider the employees themselves as a variable factor wherein in many instances it is their availability that is the dominant scheduling dynamic. For example, students at University will have varying lesson schedules which may be coupled to varying loads from interests and/or sports. Accordingly, it would be beneficial for an employee scheduling software system to account for employees with varying schedules, particularly part-time employees.

A. R. Henry et al in U.S. Pat. No. 6,957,188 entitled “Computerized-Interactive Shift Trade Recording System” teach to a scheduling software system wherein an employee may trade a shift to another employee upon verification that the receiving employee has the appropriate credentials and that the shift being traded does not lay within a time limit. However, Henry does not address the expiration of credentials which may relate to credentials issued by local, state or Federal Government organizations. In other circumstances an employee's credentials may not initiate until a future point in time due to regulatory requirements, legal issues, etc. Similarly, reality in many environments is that employees may trade shifts with very short time spans between the trade and shift start. Accordingly, it would be beneficial for an employee scheduling software system to incorporate expiration/initiation of credentials associated with employees.

L. Garcia et al in U.S. Patent Applications 2006/0,224,477 and 2008/0,046,305 entitled “Automated Auction Method for Staffing Work Shifts” similarly teach an employee scheduling software system that offers shifts for auction to employees wherein an employee is allocated based upon their credentials being valid for the position being offered and either their having the lowest entered wage for the position or their having accumulated the most “reward” points for performing assignments. In the latter scenario those employees performing well in completing assignments are preferentially eligible for taking shifts that are offered whilst in the former scenario the organization seeks to minimize salary expenses. However, it would be beneficial in many circumstances that acceptance of a shift is determined in dependence upon parameters established by the current shift owner who may only be willing to trade when an offer meets their criteria.

T. LaJoie et al in U.S. Patent 2008/0,319,822 entitled “Method and System for Creating and Trading Schedules” teach to an employee scheduling software system wherein each employee is able to establish a set of rules based upon the relative importance and weighting of criteria established by the employee. The preferential bidding system therefore takes these criteria from all the employees in allocating the shifts available for allocation when it creates a new schedule. LaJoie teaches to a visual filtering system for an employee wishing to trade wherein multiple filters can be specified but assumes there are other shifts to trade but does not explain how their shift is accepted unless it is assumed placed into the same pool from which they select.

Disadvantageously this implies the organization can be left with shifts without employees to fulfill them. This issue can be considered as being an extension of an issue inherent within the other prior art systems wherein an employee trading a shift has no ongoing responsibility. It would be beneficial for shifts to be considered as “owned” until another employee “clocks in” and accordingly failure to have the shift “covered” leads to the employee offering the shift for trade or auction being penalized.

Accordingly, it would be beneficial for an employee scheduling software system to overcome the disadvantages of the prior art. Further, it would be beneficial if the employee scheduling software system was able to access multiple extrinsic databases that host schedules relating to an employee thereby allowing the scheduling to avoid external conflicts when generating schedules for the employer and allowing the employee to respond to trade/auction events from other employees with confidence.

Advantageously, the employee scheduling software system associates one or more portable electronic devices to the employee wherein communications relating to their schedule are transmitted to the portable electronic devices. Additionally these portable electronic devices by virtue of their association to the employee may provide the employer with a more accurate clocking in/out process to verify the employee's attendance and completion of their shift.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations in the prior art with respect to employee scheduling and more particularly to a computer system providing enhanced interfaces and information management.

In accordance with an embodiment of the invention there is provided a method comprising:
providing a portable electronic device associated to an individual comprising a memory and microprocessor and supporting wireless communications according to a first predetermined standard;
providing a computer comprising a memory and microprocessor and supporting communications to a network;
generating on the computer a schedule relating to an organization comprising a plurality of shifts, each shift associated with an employee of a plurality of employees and a location relating to the organization, wherein one of the plurality of employees is the individual;
verifying execution of a shift in the schedule relating to the individual based upon establishing wireless communications between the portable electronic device and wireless infrastructure operating according to the first predetermined standard associated with the location relating to the shift.

In accordance with an embodiment of the invention there is provided a method comprising:
providing a portable electronic device associated to an individual comprising a memory and microprocessor and supporting wireless communications according to a first predetermined standard;
providing a computer comprising a memory and microprocessor and supporting communications to a network;
generating on the computer a schedule relating to an organization comprising a plurality of shifts, each shift associated with an employee of a plurality of employees and a location relating to the organization, wherein one of the plurality of employees is the individual;
verifying execution of a shift in the schedule relating to the individual based upon establishing the employee's location relative to the location relating to the shift.

In accordance with an embodiment of the invention there is provided a method comprising:
providing a first portable electronic device associated to an individual comprising a memory and microprocessor and supporting wireless communications according to a first predetermined standard to a network;
receiving on the first portable electronic device first schedule data relating to a schedule of an organization comprising at least a shift of a plurality of shifts, each shift associated with an employee of a plurality of employees and a location relating to the organization, wherein one of the plurality of employees is the individual;
receiving on the first portable electronic device a trade shift request from the individual relating to a shift within their schedule with another individual having a shift within their schedule that the individual wishes to trade for their shift;
verifying on the first portable electronic device whether the trade shift request complies with at least a first rule of a plurality of first rules stored within a rule database on the portable electronic device; and
transmitting trade shift request data to the another individual relating to the trade shift request in dependence upon at least the determination of the verification.

In accordance with an embodiment of the invention there is provided a method comprising:
providing a computer comprising a memory and microprocessor and supporting communications to a network;
storing on the computer schedule data relating to a schedule of an organization comprising at least a shift of a plurality of shifts, each shift associated with an employee of a plurality of employees and a location relating to the organization;
storing on the computer at least a first rule of a plurality of first rules;
extracting a predetermined portion of the schedule data relating to schedule relating to a predetermined portion of the plurality of shifts relating to the employee of the plurality of employees;
extracting a predetermined portion of the plurality of first rules, the predetermined portion determined in dependence upon at least the predetermined portion of the plurality of shifts relating to the employee of the plurality of employees; and
transmitting the predetermined portion of the schedule data and the predetermined portion of the plurality of first rules to an electronic device associated with the employee of the plurality of employees.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a display screen presented to a manager for scheduling employees by a scheduling software system according to an embodiment of the invention;

FIG. 2 depicts a display screen presented to a manager for managing employees at a location by a scheduling software system according to an embodiment of the invention;

FIG. 3 depicts a display screen presented to a manager for managing shift characteristics by a scheduling software system according to an embodiment of the invention;

FIG. 4 depicts a display screen presented to a manager for generating reports by a scheduling software system according to an embodiment of the invention;

FIG. 5 depicts display screens relating to employees, their credentials and approved locations by a scheduling software system according to an embodiment of the invention;

FIG. 6 depicts a system overview for a scheduling software system according to an embodiment of the invention;

FIG. 7 depicts a display screen presented to an employee remotely relating to their availability by a scheduling software application according to an embodiment of the invention;

FIG. 8 depicts a display screen presented to an employee remotely relating to their availability by a scheduling software application according to an embodiment of the invention;

FIG. 9 depicts a display screen presented to an employee remotely relating to their skills and certification by a scheduling software application according to an embodiment of the invention;

FIG. 10 depicts a display screen presented to an employee remotely relating to their time sheet by a scheduling software application according to an embodiment of the invention;

FIG. 11 depicts a display screen presented to an employee remotely relating to trading shifts by a scheduling software application according to an embodiment of the invention;

FIG. 12 depicts a display screen presented to an employee remotely relating to auctioning a shift via a scheduling software application according to an embodiment of the invention;

FIG. 13 depicts a display screen presented to an employee remotely relating to auctioning a shift via a scheduling software application according to an embodiment of the invention;

FIG. 14 depicts an application environment for a scheduling software system according to an embodiment of the invention; and

FIG. 15 depicts a display screen presented to an employee remotely relating to their schedule and conflicts/trades with cross-reference to identified databases relating to the employee by a scheduling software application according to an embodiment of the invention;

FIG. 16 depicts a display screen presented to a user of a scheduling software application during loading of the application on their portable electronic device according to an embodiment of the invention;

FIG. 17 depicts a display screen presented to a user of a scheduling software application during schedule review on their portable electronic device according to an embodiment of the invention;

FIG. 18 depicts a display screen presented to a user of a scheduling software application during a schedule review with option to trade shifts on their portable electronic device according to an embodiment of the invention;

FIG. 19 depicts an alert screen presented to a user of a scheduling software application during a trading shifts on their portable electronic device according to an embodiment of the invention;

FIG. 20 depicts a shift detail screen presented to a user of a scheduling software application during review on their portable electronic device according to an embodiment of the invention;

FIG. 21 depicts a mapping screen presented to a user of a scheduling software application on their portable electronic device according to an embodiment of the invention;

FIG. 22A depicts mapping screen versions presented to a user of a scheduling software application on their portable electronic device according to an embodiment of the invention;

FIG. 22B depicts a public transport display presented to a user of a scheduling software application on their portable electronic device according to an embodiment of the invention.

FIG. 23 depicts an alert screen presented to a user of a scheduling software application on their portable electronic device according to an embodiment of the invention;

FIG. 24 depicts a settings screen presented to a user of a scheduling software application on their portable electronic device according to an embodiment of the invention;

FIG. 25 depicts an exemplary system overview and process flow for a scheduling software application invoking centralized and distributed rules in managing schedules according to an embodiment of the invention; and

FIG. 26 depicts an exemplary system overview for a scheduling software application accessing distributed information resources with respect to managing schedules according to an embodiment of the invention.

### DETAILED DESCRIPTION

The present invention is directed to computer systems for employee scheduling and more particularly to a computer system providing enhanced interfaces and information management.

Within the following description reference may be made below to specific elements, numbered in accordance with the attached figures. The discussion below should be taken to be exemplary in nature, and not as limiting the scope of the present invention. The scope of the present invention is defined in the claims, and should not be considered as limited by the implementation details described below, which as one skilled in the art will appreciate, can be modified by replacing elements with equivalent functional elements or combination of elements. Within these embodiments reference will be made to terms which are intended to simplify the descriptions and relate them to the prior art, however, the embodiments of the invention should not be read as only being associated with prior art embodiments.

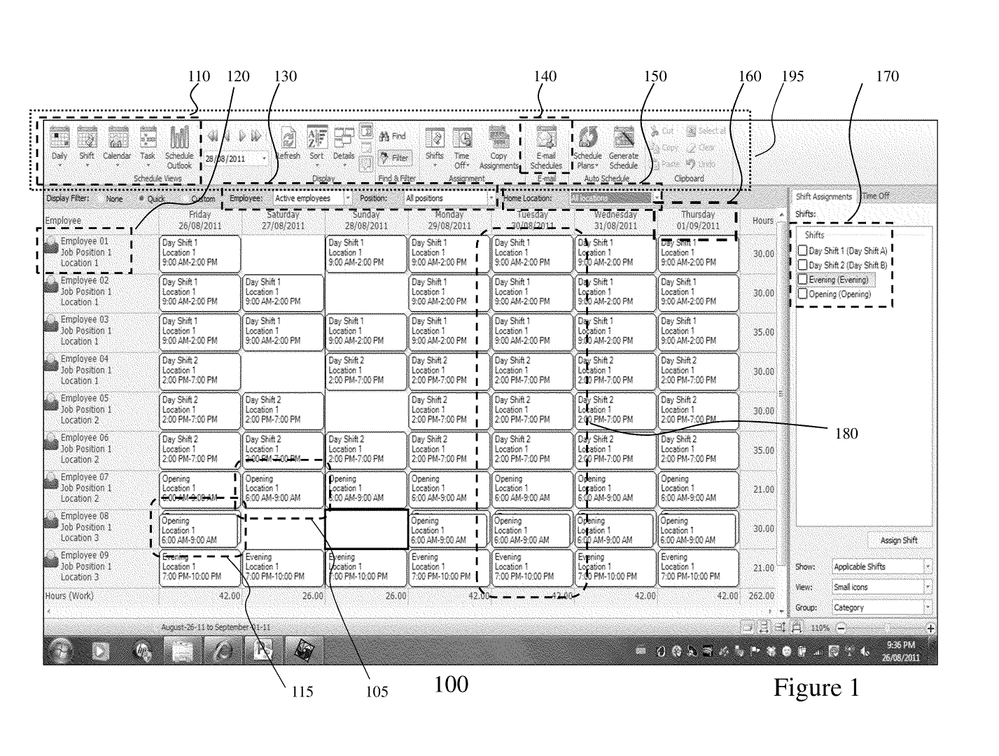

Referring to FIG. 1 there is depicted a display screen 100 presented to a manager for scheduling employees by a scheduling software system according to an embodiment of the invention. Accordingly display screen 100 presents to the manager of an organization a navigation pane 195 that includes schedule block 110 and email block 140 amongst the multiple elements of the navigation pane that allow the manager to access multiple functions within the scheduling software system as well as adjust the information presentation format. As shown display screen 100 presents a calendar view presenting employees, such as “Employee 1” 120 along the left hand side and days, such as “Thursday Sep. 1, 2011” 160, across the top with a corresponding matrix of the shifts that each employee has, such as single shift 105 for “Employee 7” on Saturday Aug. 27, 2011 wherein they are on “Opening Location 1 6:00 am-9:00 am” denoting that they will be opening at “Location 1” wherein this shift runs 6:00 am to 9:00 am. Also shown is double shift 115 for “Employee 8” on Friday Aug. 26, 2011 wherein the indicated shift is similarly “Opening Location 1 6:00 am-9:00 am” denoting that they will be opening at “Location 1” wherein this shift runs 6:00 am to 9:00 am.

The manager can also see from day list 180 shifts assigned to the employees upon a specific day, for example Tuesday Aug. 30, 2011 or may through selection of shifts in shift selector window 170 restrict the shift or shifts displayed, for example being interested only in assignment of the opening shift. Likewise employee selector window 130 and location window 150 allow the manager to restrict the locations, the employees, and positions to be displayed. For example, a manager may wish to see only employees associated with “Location 1” who are supervisors in the instance the organization is a restaurant chain or baristas associated with all locations if the organization is a chain of coffee shops.

Schedule block 110 allows the manager to view the scheduling of employees based upon different selections such as “Daily”, “Shift”, “Calendar” and “Task.” Once the manager believes the schedule to reflect their requirements they can via email block 140 send the schedule to all their employees. Within the description of this FIG. 1 and other figures within the specification terms such as manager, supervisor, employee etc are used. They are not to be viewed as limiting in respect of the embodiments described but merely reference to usually associated terms and associated responsibilities/roles of different people within an organization. A manager may also be a supervisor and an employee. Once the manager has completed the scheduling then the results may be, for example, published to an employee portal for accessing through a web browser and published to a scheduling software application as discussed below in respect of embodiments of the invention wherein the users PEDs for example receive the updated schedule to the scheduling software application in execution upon their PED.

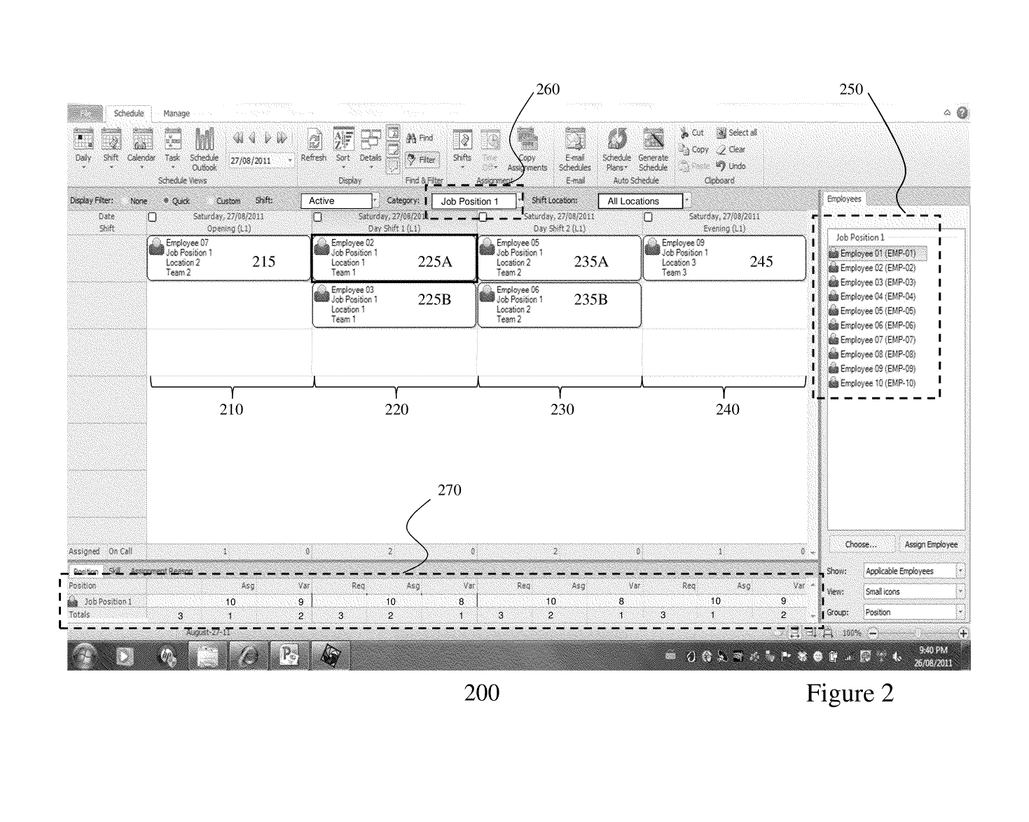

Referring to FIG. 2 there is depicted a display screen 200 presented to a manager for managing employees at a location by a scheduling software system according to an embodiment of the invention. In this instance the manager has elected to a single day, Saturday Aug. 27, 2011, and is presented with employee shifts for that day where the employees are associated with a “Job Position 1” as selected in category window 260 resulting in employee list 250 also being displayed. As presented to the user the day is split into the shifts, being “Opening” 210, “Day Shift 1” 220, “Day Shift 2” 230, and “Evening” 240. Accordingly, the manager can see first assignment 215 for “Employee 7” in “Location 2” for “Opening” 210, second and third assignments 225A and 225B respectively for “Day Shift 1” 220, fourth and fifth assignments 235A and 235B respectively for “Day Shift 2” 230, and sixth assignment 245 for “Evening” 240. Therefore it would be evident to the manager, assuming all three locations are open for the same 4 shifts and that employees having “Job Position 1” are required at each location for each shift, that at present the schedule comprises:
2 employees in “Location 1” but that they are both scheduled for “Day Shift 1” 220 through second and third assignments 225A and 225B respectively;
2 employees in “Location 2” scheduled together for “Day Shift 2” through fourth and fifth assignments 235A and 235B respectively;
1 employee in “Location 2” for “Opening” through first assignment 215; and
1 employee in “Location 3” for “Evening” through sixth assignment 245.

Accordingly, analysis block 270 presents the totals to the manager in terms of number of employees available for that shift, how many have been assigned, and the variances from required and number remaining available to assign. As the manager selects a shift, such as “Day Shift 1” 220 the employee list 250 will adjust to reflect those able to work at that time.

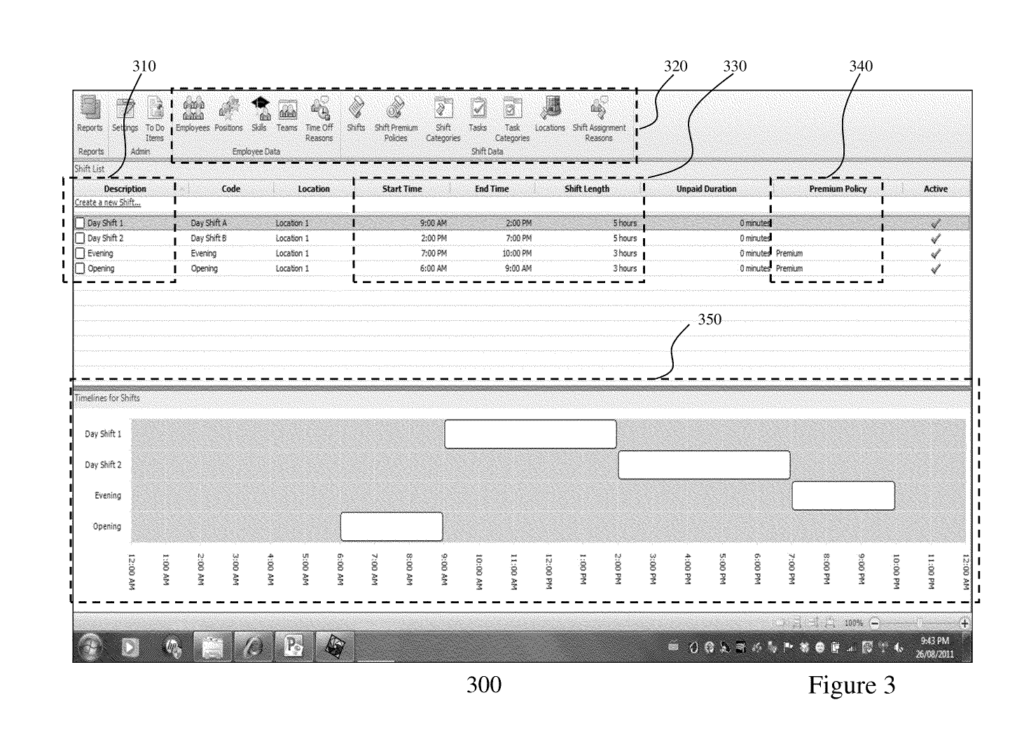

Now referring to FIG. 3 there is depicted a display screen 300 presented to a manager for managing shift characteristics by a scheduling software system according to an embodiment of the invention. Accordingly, the manager via navigation pane 320 may create, edit, and delete shifts as well as other aspects of managing the organization staffing requirements such as positions, teams, skills, etc as well as assigning tasks to shifts, required skill level(s), premiums, etc. Accordingly, the manager has created 4 shifts as shown by shift list 310 which have associated start, finish, and duration displayed in time window 330 and associated premiums in premium policy window 340. The manager is able to visualize these shifts in time graph 350 so that overlaps etc can be seen as well as whether shifts cover all hours the location will be open or operational.

Shifts may also be active or inactive allowing the manager to adjust shift patterns on specific days such as for example Remembrance Day, being November 11 wherein in the Province of Ontario retail outlets etc are required by law to be shut until noon whereas they would normally be open. As such a different shift pattern is required on that day only and hence may be inactive for the remainder of the year until re-activated by the manager so that his display screen 300 is not cluttered with shifts that are not required. Accordingly, the manager may establish different shift patterns to reflect seasonal or legal requirements as well as to reflect variations of location. For example, a coffee shop in the central business district may have different hours and busy periods to another owned by the same organization in an area more generally associated with nightlife through a mixture of bars, restaurants etc.

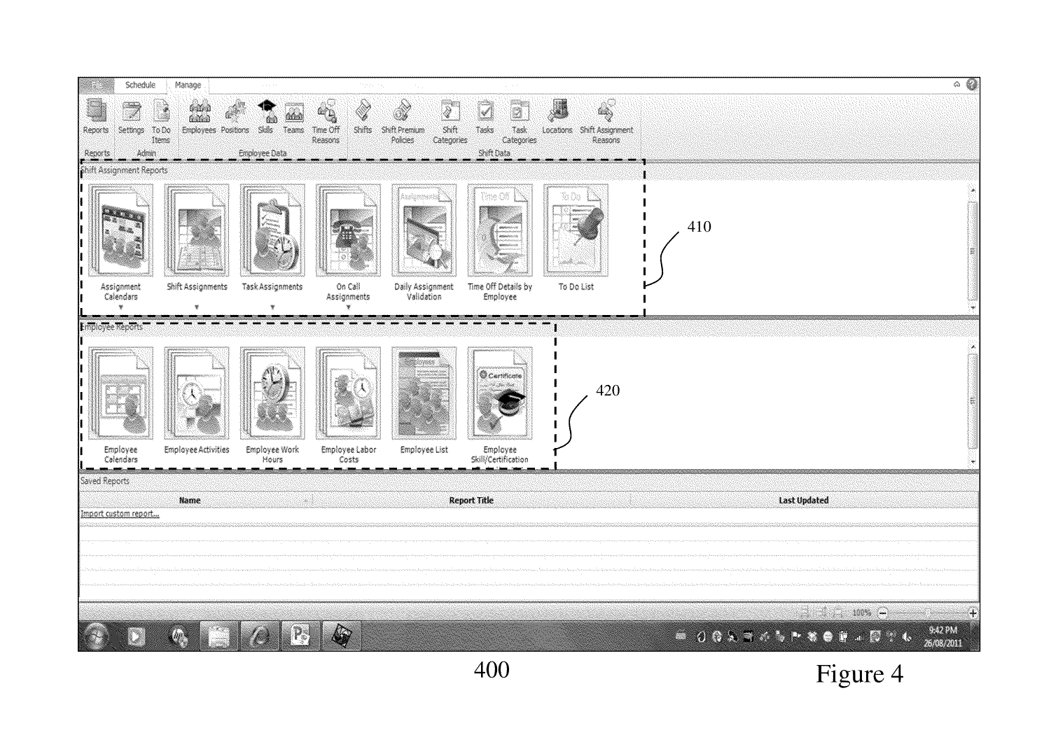

Referring to FIG. 4 there is depicted a display screen 400 presented to a manager for generating reports by a scheduling software system according to an embodiment of the invention. Unlike the other display screens discussed above in respect of FIGS. 1 through 3 the display screen 400 provides the manager with access to a series of standard or customizable reports. As shown these are broken into “Shift Assignment Reports” 410 and “Employee Reports” 420. “Shift Assignment Reports” 410 providing assignment calendars, shift assignments, task assignments, on-call assignments, daily assignment validation, time off details per employee and a to-do list. Accordingly the manager may review multiple aspects of the scheduling from the perspective of the organization. “Employee Reports” 420 in contrast provides the manager with employee calendars, employee activities, employee work hours, employee labour cost per hour, employee list and employee skill/certification wherein aspects of the scheduling and business for the organization are presented from the employee perspective. Optionally other fields may be provided within “Shift Assignment Reports” 410 and “Employee Reports” 420 such as employee sales per hour, employee incident reports, employee attendance, employee time keeping, employee shift trading history, employee shift assignment history, and customer feedback reports.

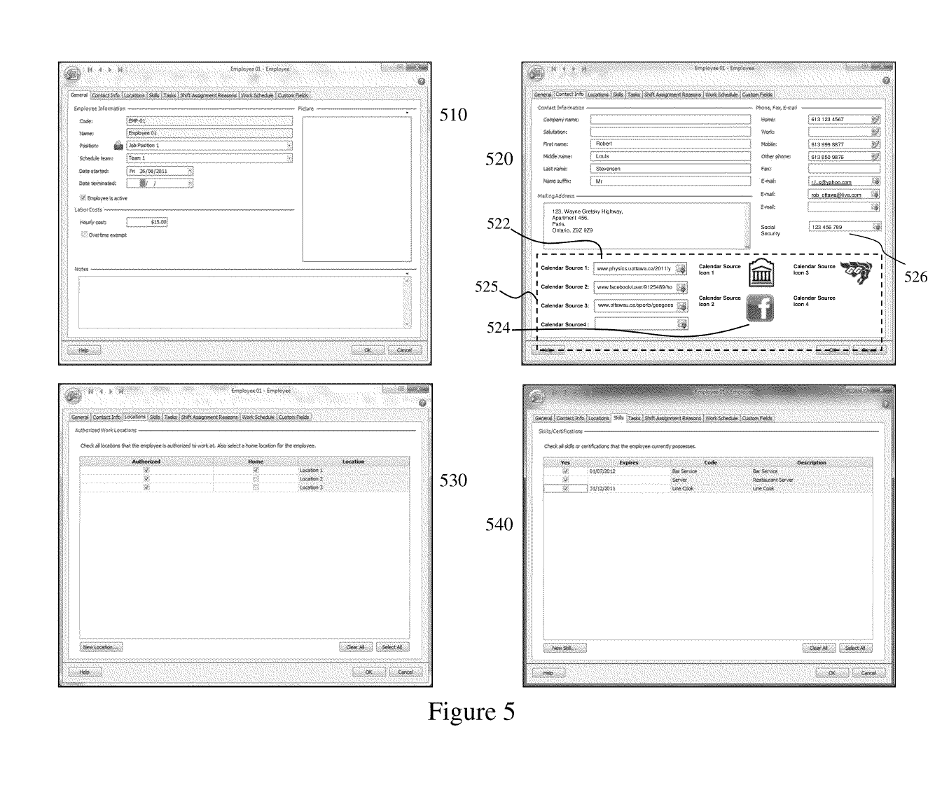

Referring to FIG. 5 there are depicted first to fourth display screens 510 through 540 respectively relating to employees, their credentials and approved locations by a scheduling software system according to an embodiment of the invention. First display screen 510 relates to data for an employee including their name, code within the organization (i.e. employee number), position, team, start date, termination date, hourly cost and fields associated with notes/picture etc. First display 510 being one tab of many accessible by the manager having selected an employee navigation icon in a navigation pane such as described above in respect of FIGS. 1 through 4. Second display screen 520 relates to personal data associated with an employee, Robert Louis Stevenson, such as full name, mailing address, home and mobile phone numbers and email addresses, in this instance two email addresses associated with the employee that may be used for contacting them as well as sending their schedule etc to these email addresses. The email address and mobile phone number may also be associated with a scheduling software application for mobile devices so that scheduling information etc is sent directly to their mobile device and accessed through the application.

Also entered is the employee's social identity number (SIN, Canada) or social security number (SSN, US) that uniquely identifies the individual and allows the organization to provide financial data to Government agencies including for example Internal Revenue Service (IRS, US), Canada Customs and Revenue Agency (CCRA, Canada), US Department of Health or financial institutions such as banks, insurers for example.

However, second display screen 520 also contains calendar cross-reference block 525 which contains references to sources of calendar information relating to the employee provided by the employee such that when the manager is preparing the schedule and selects the employee prior commitments are retrieved from these sources. For each reference a web address 522 is provided from which an icon 524 is retrieved. These icons being used to identify the source of the conflict when the manager is scheduling allowing the scheduling system to provide additional information to the manager in scheduling so that they can ascertain the “hardness” of the conflict. As shown these web addressed 522 and icons 524 relate to the University of Ottawa Physics Department, Facebook™, and University of Ottawa GeeGees football team of which the employee Robert Louis Stevenson is a member whilst attending the University of Ottawa and studying Physics. Accordingly, a conflict triggered by University of Ottawa Physics Department and University of Ottawa GeeGees football team may be viewed by the manager as a “hard” commitment for the employee whereas one arising from Facebook™ may be a soft one wherein the manager may schedule despite the highlighted conflict and wait to see if the employee seeks to trade or auction the shift.

Third display screen 530 provides information relating to which locations the employee to which it relates is authorized to work by the organization. In this instance the employee is authorized to all three locations but it would be evident that some employees may be authorized only to some locations or even a single location. The third display screen 530 also denotes that “Location 1” is considered the home location for the employee and hence they will be preferentially scheduled to this location unless an issue requires the manager to schedule them to another location. As evident in respect of descriptions below the employee is able to trade shifts with other employees and accordingly the employee may only accept in a trade a shift for a location for which they are authorized. Fourth display screen 540 presents the job descriptions for which the employee is authorized to work for the organization.

Accordingly, this employee may work as a bar tender, from the bar service code, as a restaurant server, from restaurant server code, and line cook, from line cook code. Other employees may be authorized for only one or two of these positions or for other positions this employee is not authorized for. However, in this instance due to local, state or Federal law the jobs of bar tender and link cook require certification of workers to comply with regulations such as periodic testing, training etc. Accordingly, the system denotes this employee is authorized to be a bar tender until Jul. 1, 2012 and as line cook until Dec. 31, 2011. Accordingly, the scheduling system will not allow an employee to be scheduled past their authorization date for these job functions unless they present the manager with proof of an extension in their authorization in which event the authorization expiration date would be updated.

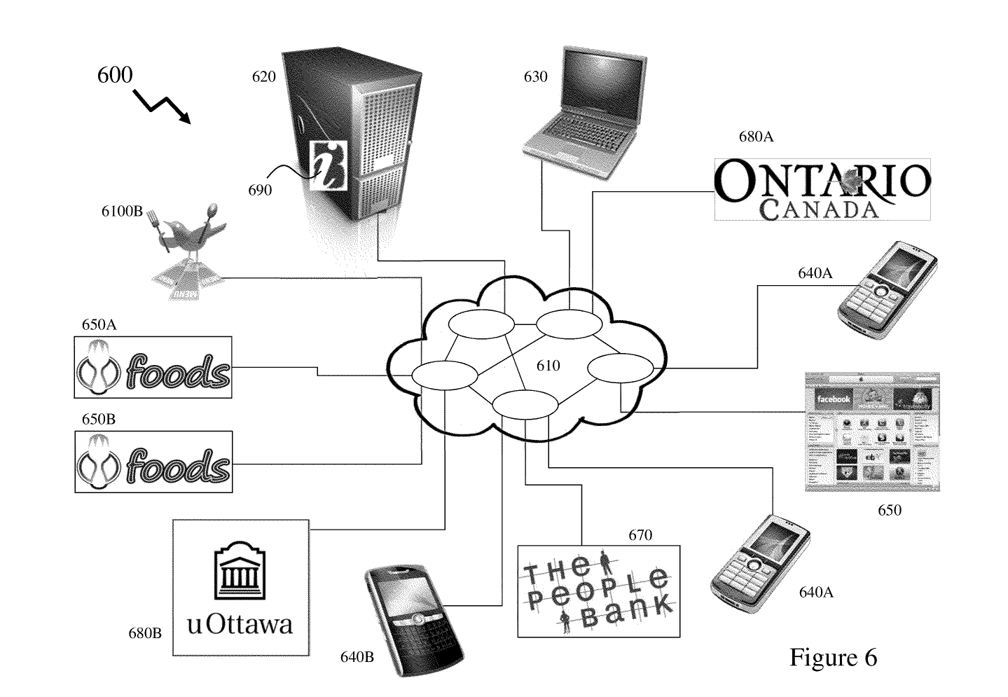

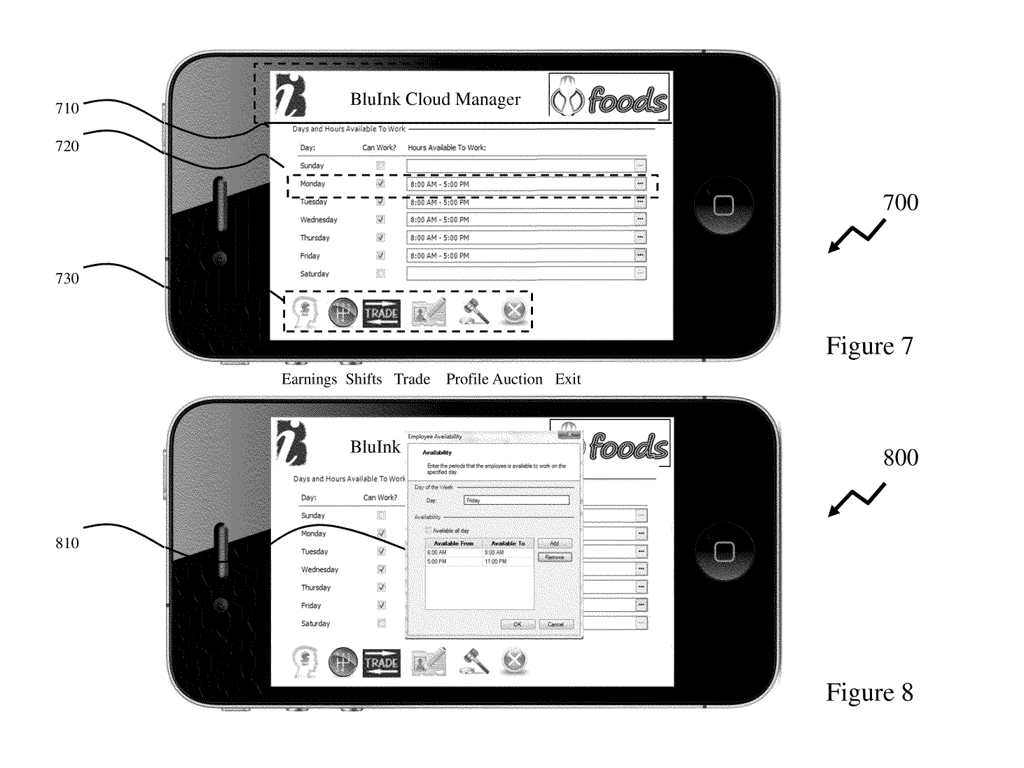

Now referring to FIG. 6 there is depicted a system 600 for a scheduling software system 690 according to an embodiment of the invention. Accordingly the scheduling software system 690 is depicted as installed on a computer server 620 which is connected to a network 610, such as the Internet for example. Also connected to the network is remote laptop 630 wherein a manager may access the scheduling software system 690 via the network 610 to perform various tasks including, but not limited to, those described above in respect of FIGS. 1 through 5 and as relate to management/organization functions described in respect of FIGS. 7 through 15 below. Also connected to the network 610 and therein to the server 620 are first and second locations 650A and 650B respectively which are physical locations of the organization running the scheduling software system 690. As such managers at these locations or shift supervisors etc may obtain information or establish schedules similar to a manager accessing via remote laptop 630.

The scheduling software system 690, as described above may send schedule information to employees via email or alternatively push the schedule information to a software application operating upon a portable electronic device associated with the employee, such as their cellular telephone, smart phone, portable multimedia player, etc. Accordingly employees receiving these schedules as well as other information, as described above in respect of FIGS. 1 through 5 and below in FIGS. 7 through 15 via their personal computers and/or portable electronic devices. Accordingly they are shown connected to the network cellphones 640A and smartphones 640B associated with employees, supervisors and managers. Employees access scheduling information either from received emails or through an application downloaded from an application store 650 where the scheduling software application for mobile devices is hosted. The scheduling software system 690 can also access regulatory authority databases, such as Ontario Government 680A, allowing regulatory information/certifications etc to be retrieved/verified and employee applicable references, such as calendar data from University of Ottawa 680B, allowing scheduling information relating to an employee or employees to be retrieved.

The scheduling software system 690 by accessing regulatory authority databases, such as Ontario Government 680A, can ensure that its policies comply with local regulatory requirements which can be important for organizations that have locations crossing jurisdictional boundaries such as provincial or state lines for example. Further, as these regulations evolve the organization is always compliant plus can adapt to changes, including but not limited to statutory holidays, maximum hours for employees with age, statutory rest schedules, etc. As will be evident from descriptions in respect of FIGS. 7 through 15 below the scheduling software system 690 in accessing employee applicable references, such as school schedules, sports schedules etc can reduce the occurrences of employees subsequently trading and adjusting schedules so that there is increased confidence for the manager and organization that the schedule generated will be executed and the appropriate personnel will be present on the assigned shifts as required by the organization.

Also accessible by the scheduling software system 690 via network 610 is employee provider 670, in this example “The People Bank.” Employee provider 670 allows the manager when scheduling with the scheduling software system 690 to request temporary staff or seek permanent staff based upon the scheduling requirements for the organization and the currently accessible employee pool. Also accessible is a social network group 6100A relating to the industry within which the organization executing the scheduling software system 690 operates, i.e. in this instance “Foods” which is a restaurant and hence the group relates to employees of restaurants which may be geographically specific, e.g. Seattle, Ottawa, and San Jose. As will be evident from descriptions below in respect of activities of the scheduling software application and employees seeking to trade/auction shifts or employers executing the scheduling software system 690, or scheduling and seeking shifts covered or recruiting part-time/full-time employees posts may be made to the social network group 6100A and thereby accessible to all members of the group. Examples of social network group 6100B being LinkedIn™ and Yahoo™. Alternatively, a distributive network application 6100B may have employees and/or the organization as members as well as other organizations and employees allowing information to be actively distributed rather than passively posted. Examples of such distributive network application 6100B being Twitter™ and FaceBook™. For example a Twitter™ group for restaurants in Ottawa may be followed by part-time/full-time staff of restaurants in Ottawa and thereby receive “Tweets” posted such as “Shift Available—Tonight Tues 30—Red Lobster Merivale 5:00 pm to 11:00 pm Double Time.” Accordingly, social network group 6100A and distributive network application 6100B allow employees and organizations to communicate either within the single organization, across organizations or within employee groups and exchange information.

It would also be evident that according to another embodiment of the invention that an employer or organization may post employment opportunities, both permanent and temporary, to the scheduling software system and/or scheduling software application for distribution to employees as well as other users of the scheduling software system and/or scheduling software application generally or those related to organizations having employee skill pools and/or other characteristics aligned to the organization seeking to add staff. It would be evident that an employer seeking a chef for example with particular accreditation may therefore have their staff opportunity only distributed to those with that accreditation in their profile thereby reducing the number of resumes received from under-qualified individuals and wasted time of the employer. According to other embodiments users may view job postings within a list and/or map either generally within the area they live or specifically in terms of a particular region around their current employment if travel to/from their home is particularly convenient for example via public transport at the times their typical shift schedules would end which may be late night, early morning for example.

Scheduling software system 690 may also trigger a request to an employee provider 670 where no employee is available for a shift(s) or where the absence of employees when scheduling reaches a threshold. As such the scheduling software system 690 provides to employee provider 670, under manager direction or automatically, information regarding shifts to be fulfilled from contract staff registered with employee provider 670. It would be apparent to one skilled in the art that employee provider 670 may themselves exploit one or more social network groups 6100A and/or distributive network applications 6100B in communicating with their contract staff or seeking to fulfill the requirements of the organization.

It would be apparent to one skilled in the art that the computer server 620 may be a stand-alone computer system, a localized cluster of computer systems, or a distributed cluster of computer systems interconnected through a network such as the Internet for example, commonly referred to as a cloud computing environment.

It would be evident that many of the functions identified for the scheduling software system 690 as being performed by the manager may also be performed automatically by the scheduling software system 690 according to rules established relating to employees including, but not limited to, seniority, labour cost, teams etc. Alternatively, many or all of these functions may also be performed directly within a software application loaded on to the portable electronic devices associated with the employee(s) and/or manager(s). Optionally, one of the external databases accessed may be specific to the employee, such as for example a Yahoo™ or Google™ calendar wherein forward looking calendar information can be retrieved in a consolidated manner to aid the manager in scheduling. Alternatively, the scheduling software system 690 may also access a remote server or servers where organizations joining a service provided by the supplier of the scheduling software system 690 store schedules for their organizations which are then cross-referenced by SIN (or SSN) for example. In this manner the scheduled information for an employee who works for multiple organizations, i.e. University student working in coffee shop and bar, is then available to each organization of the multiple organizations the employee works for part-time on a shift basis. Optionally, other unique or non-unique identifiers may be employed including for example telephone number and email address.

Referring to FIG. 7 there is depicted a display screen 700 presented to an employee remotely using scheduling software application downloaded to a portable electronic device such as their cellphone, smartphone, PDA, portable multimedia player, or gaming device for example. Display screen 700 relating to their availability wherein the scheduling software application presents display screen 700 comprising fields 720 relating to days of the week wherein the employee may indicate that they are available for work, in this case Monday-Friday only, and what times they are available to work, in this case 8:00 am to 5:00 pm on each day they are indicating available. Also shown are top pane 710 that depicts the software provider, in this case “BluInk”, the name of the scheduling software application, “BluInk Cloud Manager”, and the organization with whom the employee works, in this instance “Foods.” Also shown is bottom pane 730 comprising navigation icons, in this instance from left to right, earnings, shifts, trade, profile, auction, and exit.

It would be evident that in some instances the employee may work for two or more organizations in which case the scheduling software application may present the employee with an initial screen, not shown, that lists these employers allowing them to select one to establish these preferences with or it may allow the employee to apply one set of preferences to all or a subset of the employers.

Referring to FIG. 8 there is depicted a display screen 800 presented to an employee remotely relating to their availability by a scheduling software application according to an embodiment of the invention. Display screen 800 presenting a second screen 810 as part of the availability entry for an employee. Accordingly, the user has highlighted Friday within the availability screen, such as display screen 700 in FIG. 7, thereby triggering the second screen 810 wherein the employee can set one or more time periods during which they are available. For example in this instance the employee is indicating availability 6:00 am to 9:00 am and 5:00 pm to 11:00 pm, such as might be the case for a student attending college for example. As described in FIG. 6 above a social network group may be followed or joined by the employee such that they receive communications from the social network group. In the example presented above the employee is following a Twitter™ group and their mobile device receives “Shift Available—Tonight Tues 30—Red Lobster on Merivale 5:00 pm to 11:00 pm Double Time.”

In this instance the scheduling software application running in background identifies the “Tweet” as being from the Twitter™ group for restaurants in Ottawa captures the “Tweet” and compares the information within it to the availability of the employee. In this instance the shift is a Tuesday from 5:00 pm to 11:00 pm which is an availability period of the employee and indicates that the rate is double due to a shortage for the “Red Lobster” restaurant on Merivale Road, Ottawa. The scheduling software application also knows that the employee is currently not working at “Foods” and hence provides a prompt to the employee on their portable electronic device so that they are aware it is available and can respond. In the event “Red Lobster” is also using the scheduling software application and scheduling software system the two systems can exchange information through a master server, not shown in FIG. 6 for clarity, as “BluInk” has registered on the master server the systems/applications relating to “Foods” and “Red Lobster.”

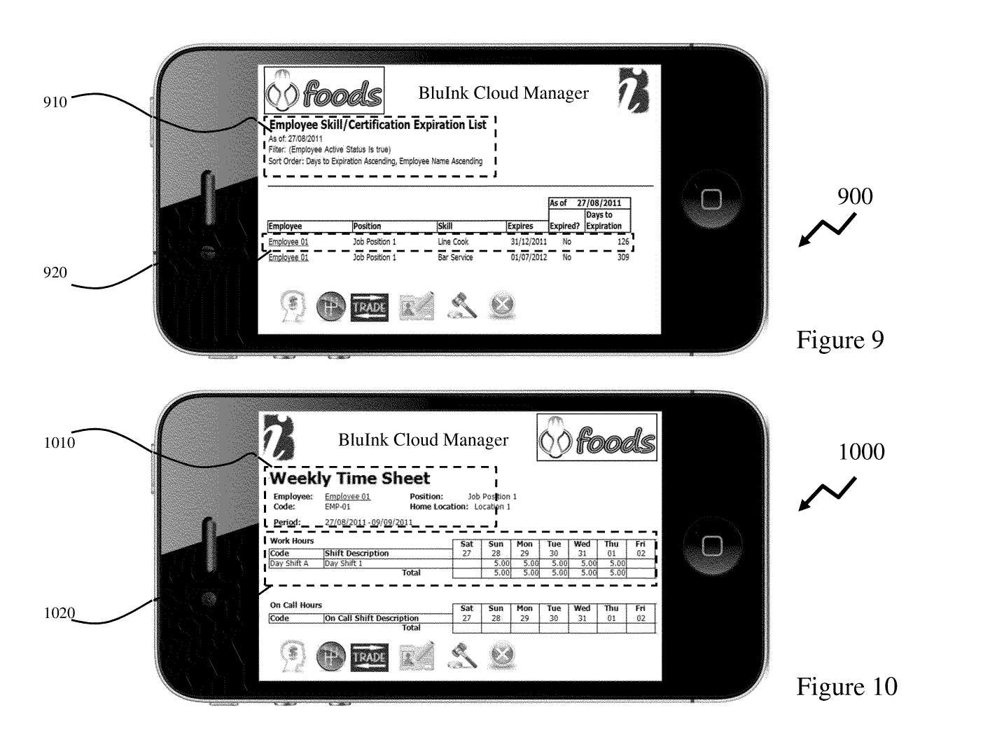

Referring to FIG. 9 there is depicted a display screen 900 presented to an employee remotely relating to their skills and certification by a scheduling software application according to an embodiment of the invention. As shown display screen 900 presents background data in information field 910 and certification data 920. In this example, the employee is shown as having a valid certification to Dec. 31, 2011 in respect of their position as “Line Cook” and Jul. 1, 2012 for their position as “Bar Tender.” The display screen 900 being provided as of Aug. 27, 2011. Accordingly, scheduling software application may also provide a reminder to the employee that a certification will expire allowing them time to address this.

Now referring to FIG. 10 there is depicted a display screen 1000 presented to an employee remotely relating to their time sheet by a scheduling software application according to an embodiment of the invention. Accordingly the display screen 1000 presents background data 1010 such as employee name, home location, position, and the period for which the time sheet applies. Also shown is work hours 1020 that shows the hours worked by the employee for each day by shift and total. A further part of the time sheet, not shown, would be that relating to the resulting earning, tax deductions and net pay. As with other display screens presented to the employee via scheduling software application the user can navigate through the navigation pane to other parts of the scheduling software application. Optionally, the time sheet information may be emailed from the scheduling software system to each employee and accessed via the scheduling software application or it may be retrieved by the scheduling software application from the server hosting the scheduling software system.

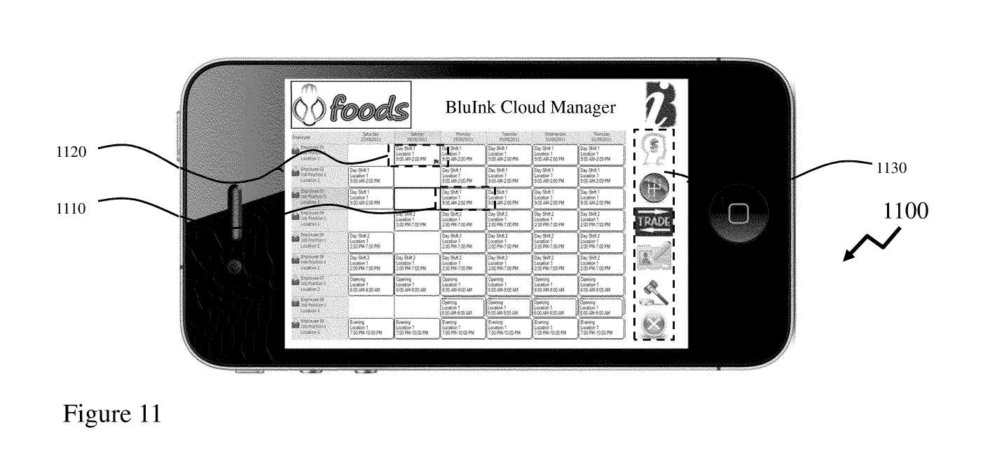

Referring to FIG. 11 there is depicted a display screen 1100 presented to an employee remotely relating to trading shifts by a scheduling software application according to an embodiment of the invention. The employee, in this instance “Employee 3”, has a Monday “Day Shift 1” 1110 which they do not wish to work. Accordingly, the employee in viewing their schedule accessed the trading shifts portion of the scheduling software application by selecting the “Trade” icon within the navigation pane 1130. This displayed display screen 1100 presents a matrix of days around that which has the shift the employee wishes to trade and shows other employees with their shifts wherein these employees all have the same job position, “Job Position 1”, as the employee. Accordingly, the employee has highlighted another shift being Sunday “Day Shift 1” 1120 currently assigned to “Employee 1.”

Upon such selection the scheduling software application sends a trade request to the employee associated with the identity “Employee 1” indicating that the employee wishes to trade their Monday “Day Shift 1” 1110 for Sunday “Day Shift 1” 1120. If the other employee accepts the trade request then the scheduling software system will swap the assignment of these shifts and update its database. Depending upon the circumstances relating to the employees desire to trade shifts the employee may offer an incentive to the other employee such as a further shift, further shifts, or other incentives.

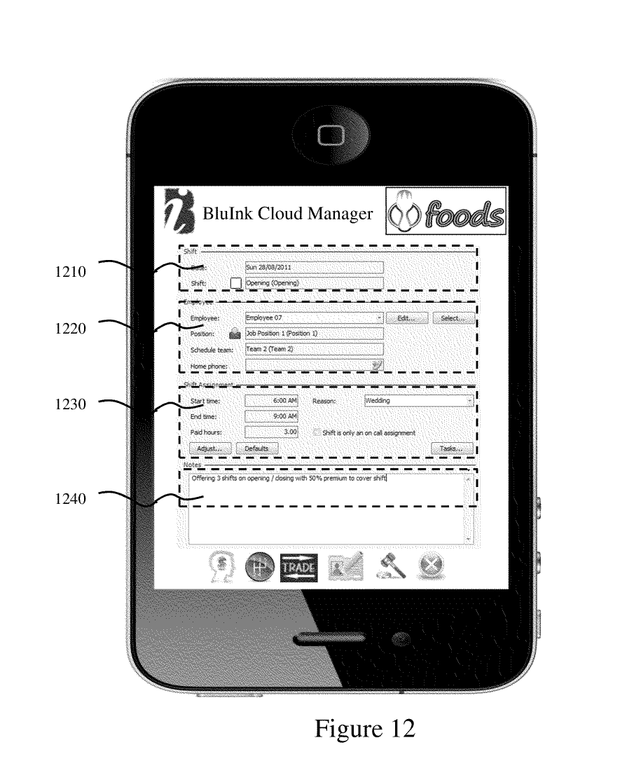

Now referring to FIG. 12 there is depicted a display screen 1200 presented to an employee remotely relating to auctioning a shift via a scheduling software application according to an embodiment of the invention. As depicted in display screen 1200 shift block 1210 contains information relating to the shift that the employee wishes to auction, similar to trading but not having a corresponding shift selected by the employee and assigned to the employee. In this instance the shift at issue is opening on Sunday Aug. 28, 2011. Employee field 1220 contains information relating to the employee whilst reason field 1230 contains time information relating to the shift being auctioned as the employee may be seeking to auction only part of the shift rather than the whole shift. Reason field 1230 also contains the reason the employee wishes to auction the shift, in this case a “Wedding.”

The employee can also add an incentive in note block 1240, in this instance the employee is offering three opening/closing shifts that have 50% shift premiums associated with them. Accordingly the employee can set an incentive commensurate with their desire to have the shift covered by another employee. Optionally, the scheduling software application and scheduling software system allow the employee to escalate the incentive if an initial auction fails to result in the employee having the shift covered. Alternatively, an employee may post a shift and have it picked up by any other qualified employee wherein the scheduling software application and scheduling software system may optionally filter the posted shift based upon the required skills of the posting employee prior to displaying its availability to other employees such that only qualified employees see the posted shift as available for them to take additional to their current shift schedule. Optionally, a manager may be required to approve any proposed shift trade prior to its being confirmed to the two employees involved.

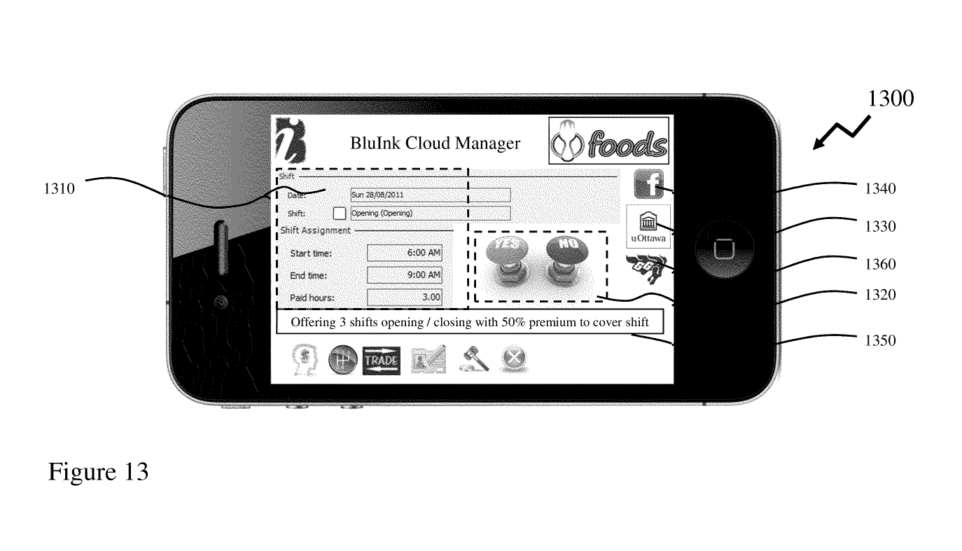

Now referring to FIG. 13 there is depicted a display screen 1300 presented to an employee remotely relating to auctioning a shift via a scheduling software application according to an embodiment of the invention. As such the employee receiving the auction is presented with an information block 1310 that identifies the shift being auctioned in terms of date, shift identity and the hours the employee auctioning is seeking to have covered. There is also depicted incentive block 1350 wherein the incentive offered by the auctioning employee is presented to the employee so that they know this information. There are also yes and no icons in response block 1320 that allow the employee to either indicate they wish to accept and cover the shift or not. Also presented are organization icons Facebook™ 1340, University of Ottawa 1330, and University of Ottawa GeeGees football 1360 which are organizations the employee has indicated impact their scheduling either to the scheduling software system, in which case they are also accessible by the manager such as discussed above in respect of FIG. 5, or have been associated by the employee on the scheduling software application only. In either case the employee by accessing one or more of the organization icons, such as University of Ottawa 1330, can access calendars and schedules within these to determine whether they have conflicts that prevent them from accepting the auctioned shift in the event that they wish to accept it.

Optionally the scheduling software application allows the employee responding to the auction communication to adjust the incentive wherein they may for example reduce the incentive against other employees wishing to take the auctioned shift in order to actually win the auction. Accordingly, in the event that multiple bids are received back the scheduling software system may evaluate the bids and determine the winning bid wherein the result of the evaluation is communicated to the employee offering the shift and the employee winning the bid. Optionally, the employee may make a counter incentive offer to the employee auctioning the shift which may be accepted thereby terminating the auction. Auctions may be of varying durations such as open in terms of period to respond up to the start of the shift being auctioned, open with an end a predetermined period of time prior to the shift (i.e. one day), or established with a predetermined period within which bids must be made (i.e. 3 days) for example.

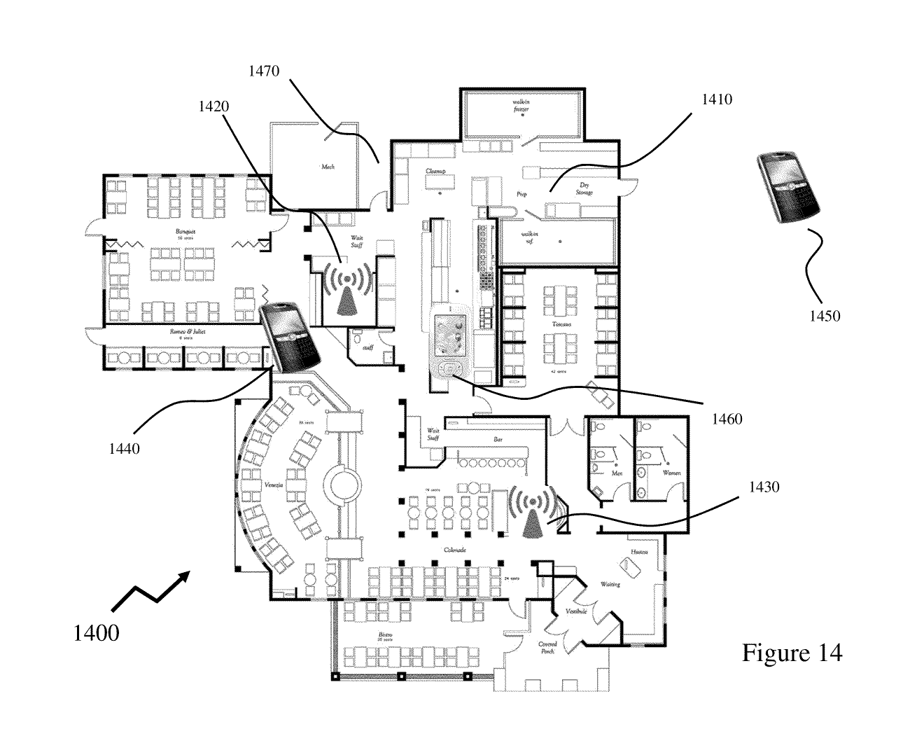

Now referring to FIG. 14 there is depicted an application environment 1400 for a scheduling software application and scheduling software system according to an embodiment of the invention. As such there is depicted a restaurant 1410 relating to a location of the organization using the scheduling software system, in this case the floor plan shows the restaurant with dining areas, kitchen, wait staff areas, office etc. Disposed within the restaurant 1410 are first and second Wi-Fi nodes 1420 and 1430 respectively. First Wi-Fi node 1420 being disposed near the kitchen, office and main wait staff area as well as staff entrance 1470. Second Wi-Fi node being disposed within the restaurant 1410 in order to provide coverage of the restaurant 1410 by first and second Wi-Fi nodes 1420 and 1430 respectively.

A first employee 1450 who has no shift and is remote from the restaurant 1410 communicates to the scheduling software system via the scheduling software application on their portable electronic device. When first employee 1450 has a shift at the restaurant 1410 they enter through the entrance 1470 wherein the portable electronic device due to the scheduling software application establishes a Wi-Fi connection to the first Wi-Fi node 1470 thereby indicating their arrival at the restaurant 1410 such that the scheduling software system denotes their presence when the current time reaches the start of their allotted shift. During their shift they carry their portable electronic devices, such as second and third employees 1440 and 1460 respectively wherein their portable electronic devices maintain connected with one or other of the first and second Wi-Fi nodes 1420 and 1430 respectively such that scheduling software system verifies their presence during their shifts.

As a typical Wi-Fi node has a range of approximately 20 meters (65 feet) indoors and potentially less in buildings with thick walls, multiple internal walls etc then the association of the Wi-Fi node(s) within a location of the organization present an effective means of “clocking-in” and “clocking-out” employees automatically and avoiding prior art approaches that are open to relatively easy fraud such as stamping time cards or initially time sheets. The scheduling software system interfacing to the first and second Wi-Fi nodes 1420 and 1430 may optionally provide a maximum time that an employee's portable electronic device is out of communication with a Wi-Fi node, for example 10 minutes, to provide allowance for them to be temporarily out of the location on a break having a cigarette or walk etc. However, outside that allotted “break” time the scheduling software system may then be set to determine that they have now left their shift and accordingly provide either an alert to a manager/supervisor at that time or in a subsequently issued report. Clearly in some circumstances the employee may have valid reasons to leave during a shift such as sickness, incident involving another family member etc wherein disciplinary measures are inappropriate.

It would be evident to one skilled in the art that the network to which the employees connect when on a shift in their assigned location may be other than Wi-Fi. Other short-range/personal area network (PAN) wireless standards may be employed such as Bluetooth, Wireless USB, Z-Wave and Zigbee for example. Other standards such as WiMAX for example may be employed but their increased range makes verifying the employee is actually in the organization's location as opposed to a few city blocks or a few mile radius difficult. Optionally, the scheduling software system may employ GPS location information derived from the employee's portable electronic device which would be transmitted periodically to the scheduling software system from the scheduling software application on their portable electronic device. In order to avoid privacy issues over tracking an employee the scheduling software application would, for example, only access GPS information on the portable wireless device and communicate this to the scheduling software system during the period of time that the scheduling software application has the employee performing a shift. Alternatively the location of the employee may be established in dependence upon characteristics of the communications from the portable electronic device supporting wireless communications with a wireless network operating according to a standard such as GSM, Wi-Fi, and WiMAX for example. Alternatively a combination of these may employed as well as establishing alternate means including but not limited to establishing near-field communications between the portable electronic device and a point-of-sale terminal at the organization's location.

It would be evident that within the scheduling software system the ability for supervisors/managers to dynamically update an employee's location for a shift would be provided either through a terminal for example in the location, such as laptop 630 in FIG. 6 for example, or through the scheduling software application on their portable electronic device which due to their entering a password and username for example registers them as supervisor/manager and provides additional display screens for them to perform supervisory/management functions. For example, mid-way through a shift a staffing issue at a second close location to the organization results in the need to transfer an employee for the remainder of their shift to the other location.

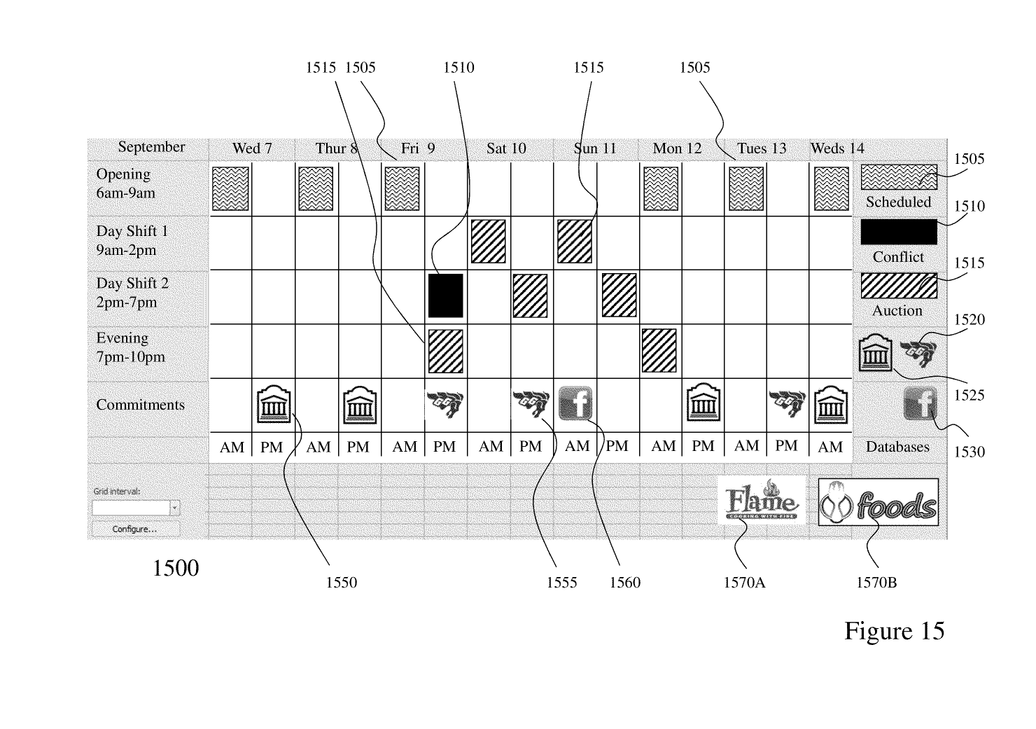

Now referring to FIG. 15 there is depicted a display screen 1500 presented to an employee remotely relating to their schedule and conflicts/trades. The display screen 1500 shows cross-references to identified databases relating to the employee by a scheduling software application in conjunction with a scheduling software system according to an embodiment of the invention. Accordingly the display screen 1500 presents on the left hand side are presented shifts and across the top days split into morning and afternoon segments. Depicted within the resulting matrix are scheduled blocks 1505 that relate to shifts that the employee has on those days, auction blocks 1515 that relate to blocks where another employee has offered the shift for auction, such as described above in respect of FIGS. 12 and 13, and conflict blocks 1510 that relate to shifts where the employee is currently scheduled but has a parallel commitment from another activity.

Also shown on the right hand side are databases relating to commitments for the employee where the employee has entered these into the scheduling software application as external databases containing scheduling information that relates to them. As shown these are University of Ottawa Physics 1525, University of Ottawa GeeGees football 1520, and Facebook™. Accordingly icons relating to these appear as first to third icons 1550, 1555, and 1560 respectively across the bottom of display screen 1500 allowing the employee to see what external commitment conflicts with their work schedule conflicts as depicted by conflict block 1510. In some instances such as Wednesday 14^{th} AM a first icon 1525 is depicted relating to an activity on the employees calendar with the University of Ottawa Physics department and a scheduled block 1505 but no conflict arises as the University of Ottawa Physics commitment occurs later in the morning to their scheduled shift which is “Opening 6 am-9 am.”

Also depicted are first and second organization icons 1570A and 1570B respectively that relate to “Flame” and “Foods” which are two organizations the employee works for. Optionally, scheduled blocks 1505, conflict blocks 1510, and auction blocks 1515 may be modified in some or all instances, as would be evident to one skilled in the art, to denote the organization to which they relate.

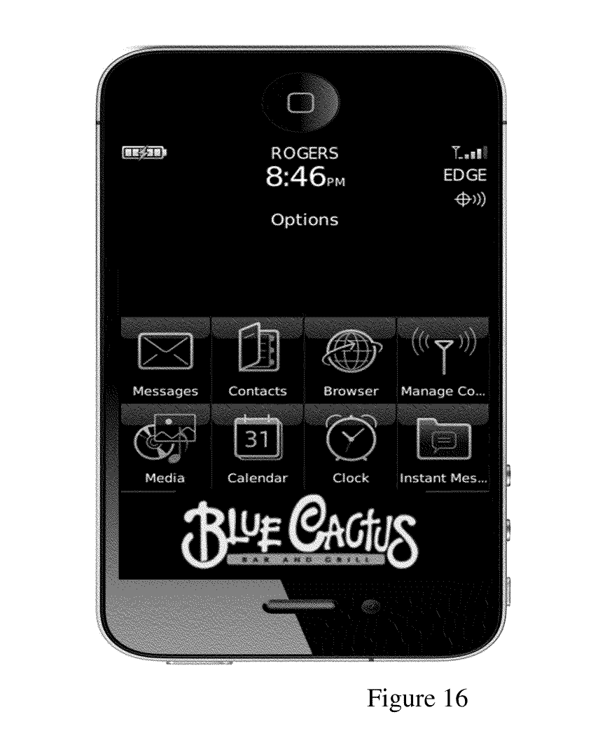

Referring to FIG. 16 there is depicted a display screen presented to a user of a scheduling software application during loading of the application on their portable electronic device according to an embodiment of the invention. This “splash screen” would appear after the user has selected the scheduling software application on the portable electronic device and presents the name of the application, “Shift-It”, and the name of the restaurant to which the application relates, in this instance ‘Blue Cactus.” Optionally this name may be replaced with alternative display options such as a scrolling list of the restaurants to which the user is registered as an employee, the name of the employee, the area to which the application relates such as Ontario through reference to the regulatory authority that the employee and/or restaurant are regulated by.

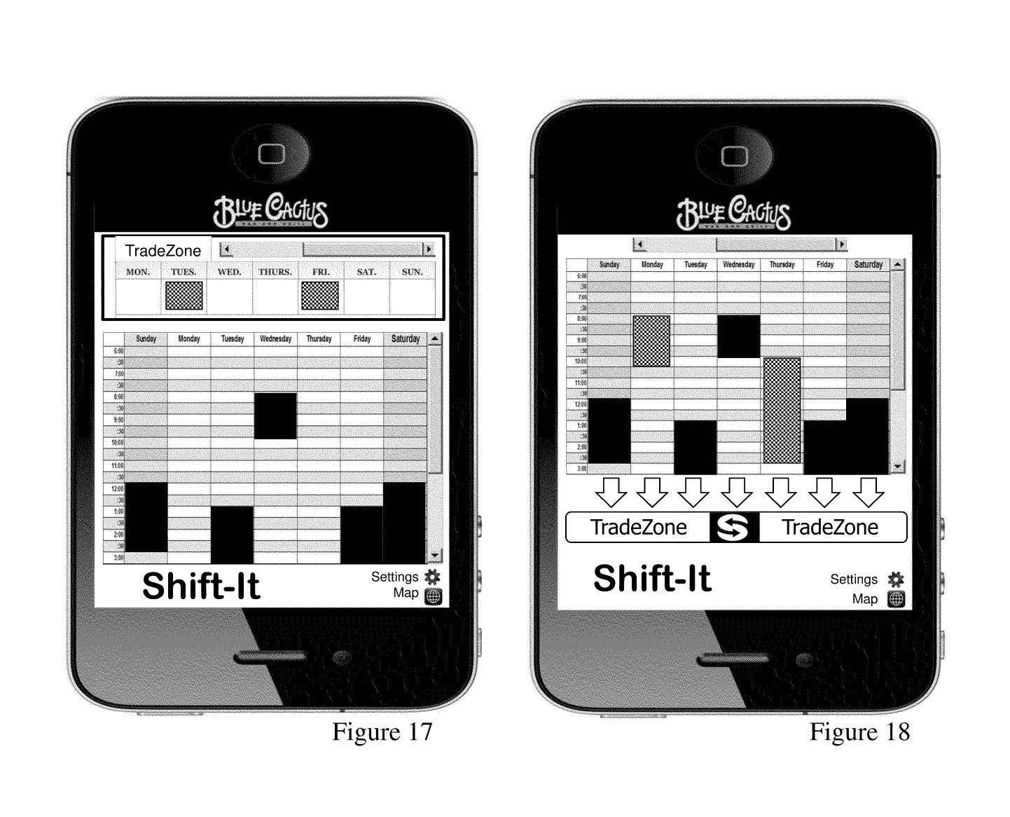

Now referring to FIG. 17 depicts a display screen presented to a user of a scheduling software application during reviewing their schedule review on their portable electronic device according to an embodiment of the invention. The schedule review shows one week at a glance. Assigned shifts for the employee are shown in the lower portion of the screen whilst the upper portion of the screen displays the fact that shifts have been added by other employees to the “TradeZone.” These shifts are those that do not overlap with currently assigned shifts of the employee and have not yet been taken by another employee. A horizontal selector control at the top of the “TradeZone” allows the user with a swipe left or right to move to an earlier or later week. Additionally, in order to allow display of days 24 hours the lower portion of the screen also includes a vertical scroll bar that when swiped up or down moves the display through the 24 hours according to the direction and duration of the scroll. In scrolling either vertically or horizontally in their respective window sections headers in each window section that may contain information such as day/date do not move.

To add a shift to the “TradeZone” the user can drag it from the schedule portion of the display to the “TradeZone.” Optionally, the user may initially tap a shift in the schedule portion to trigger a pop-up display, not shown for clarity, that may include options such as move to “TradeZone” or highlight the shift such that any subsequent dragging action relates solely to that shift even if the motion moves across another shift, such as may occur moving an evening or afternoon shift over an earlier afternoon or morning shift respectively on the same day or another day. Optionally the drag action would be verified by a subsequent sequence of presenting a pop-up window to the user with “Confirm” and “Cancel” options or “Yes”/“No” options. Optionally, the shift that has been offered for trade is highlighted to the user through an action such as a color change or pattern change for example.

Referring to FIG. 18 there is depicted a display screen presented to a user of a scheduling software application during a schedule review with option to trade shifts on their portable electronic device according to an embodiment of the invention. The schedule review shows one week at a glance but now assigned shifts for the employee are shown in the same screen as the shifts have been added by other employees to the “TradeZone.” These shifts are those that do not overlap with currently assigned shifts of the employee and have not yet been taken by another employee and are displayed in a different color or pattern or a combination of both. This screen again contains vertical and horizontal scroll bars allowing the user to move to previous or later weeks and forward/backward during the day. Below each day an arrow may be tapped by the user to move a shift currently assigned to them into the “TradeZone.” In the instance that two or more shifts for the employee exist for the same day the application would notify the employee that they must select a specific shift, for example by tapping over the shift in question, prior to selecting the shift arrow. Optionally, the selection of the shift to move into the “TradeZone” may be made after the election to place a shift into the “TradeZone.” The shift moved is then modified to allow the employee to see at a later date that they have offered the shift for trade, and upon the shift being claimed by another employee the shift would be removed from their schedule.

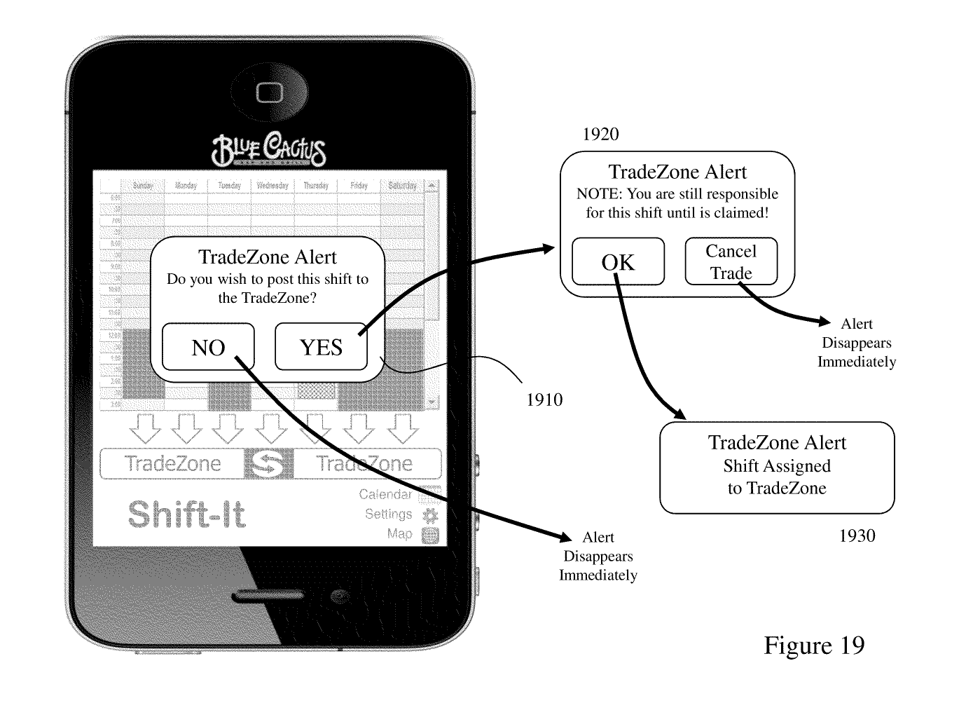

FIG. 19 depicts an alert screen 1910 presented to a user of a scheduling software application during a trading shifts on their portable electronic device according to an embodiment of the invention. Upon selection of a shift and election to offer the trade, such as performed using the display screen described above in FIG. 18, the user is presented with a double-confirmation screen sequence. In the first screen 1920 the user is asked to confirm that they wish to post the shift to the “TradeZone”, wherein if they select “No” the pop-up screen disappears otherwise it is replaced with a second pop-up screen 1930 that reminds the employee that they are still responsible for the shift until it is claimed by another employee. At this point if they select “Cancel Trade” the pop-up screen disappears otherwise it is replaced with a confirmation that the shift has been assigned to the “TradeZone.” Accordingly, the employee would be expected to perform the shift in the event that it is not claimed by another employee. Optionally, the employer may also increase this responsibility to for specific employees and/or job functions for example such as managers such that if the employee claiming their shift does not “clock-in” then they would be expected to still complete the shift as their role within the business is essential.

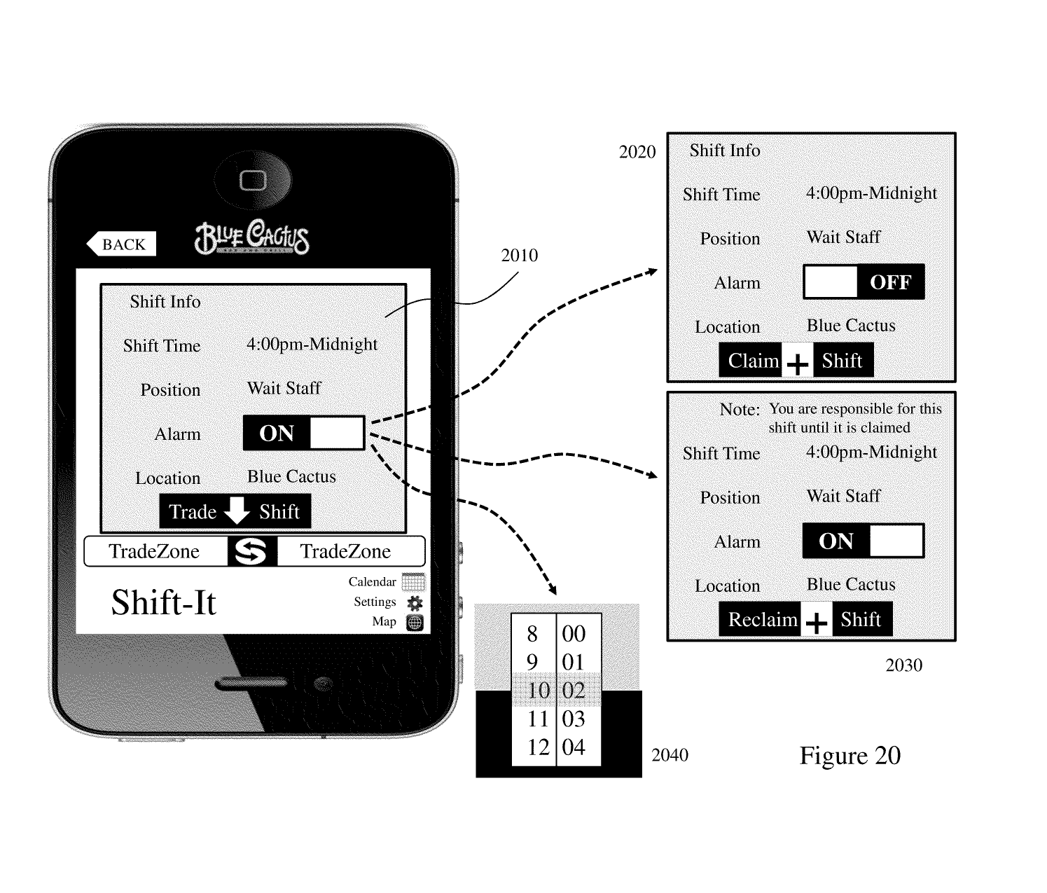

FIG. 20 depicts a shift detail screen presented to a user of a scheduling software application during review on their portable electronic device according to an embodiment of the invention. First screen 2010 as part of the shift detail screen appears when a user clicks, or taps or double-clicks, on a shift within the schedule or “TradeZone” from a calendar view such as presented above in respect of FIGS. 17 and 18 above. If the shift in question is one currently assigned to the employee then the background of the first screen 2010 is displayed in a first manner. If it is one that has been assigned by another employee into the “TradeZone” it is displayed in a second manner 2020 wherein the background may be a different colour and/or pattern to highlight this fact and the screen displayed has a “Claim Shift” option wherein if the employee clicks on the “Claim Shift” button then the shift is transferred to their current schedule and removed from the other employees.

If the shift was one assigned by the employee into the “TradeZone” and it has not been claimed by another employee at this point in time then the employee would be presented with second screen 2030 wherein a different display format may also be presented to the user along with the “Reclaim Shift” option. Hence, if the employee clicks on the “Reclaim Shift” button then the shift currently in the “TradeZone” is removed from it and transferred back to their schedule. In each shift detail screen presented to the employee an alarm option is available which can be slid from “ON” to “OFF” and vice-versa. If the employee taps the screen at this point rather than sliding the icon then time screen 2040 is displayed comprising two scroll wheels for hours and minutes respectively allowing the user to select a time at which they wish to be reminded that the shift is coming up. It would be evident that more sophisticated alarm options may be provided such as initial alarm, escalating reminder, etc.

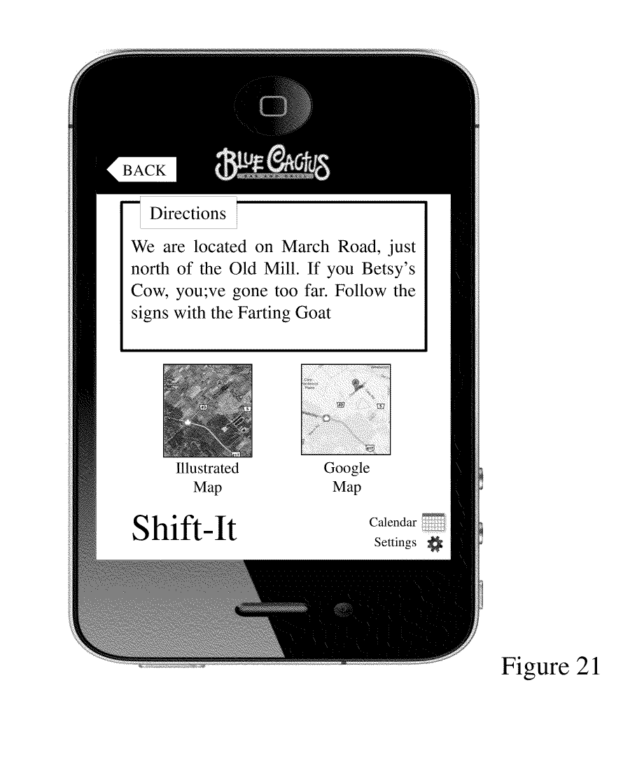

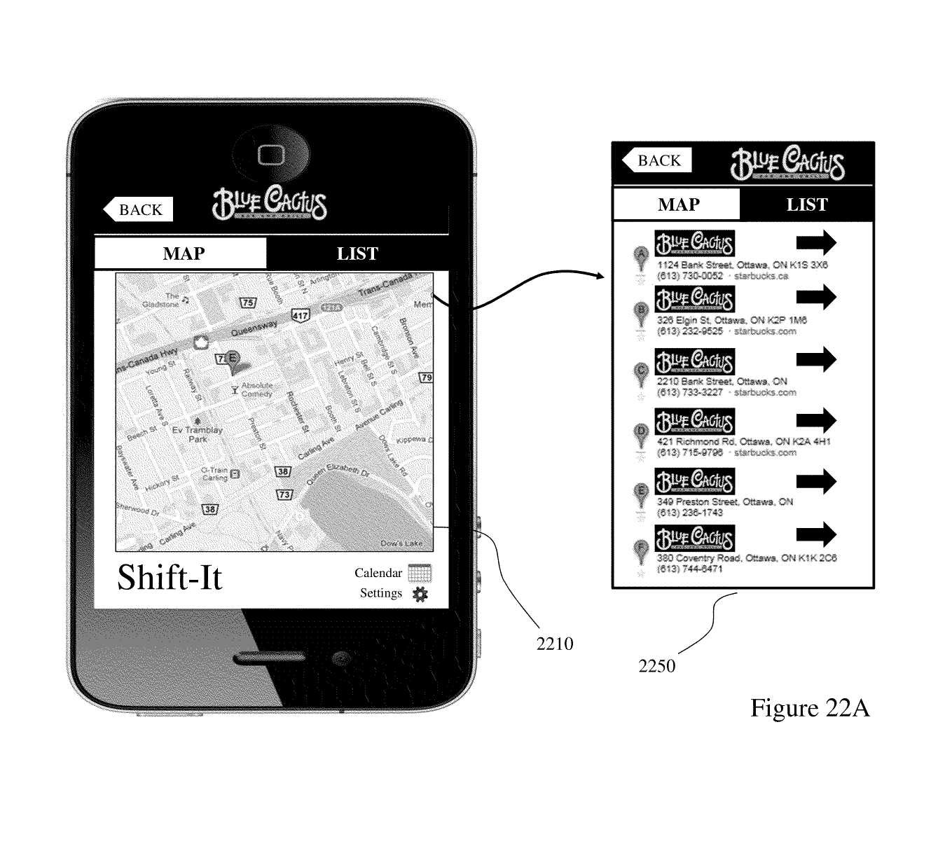

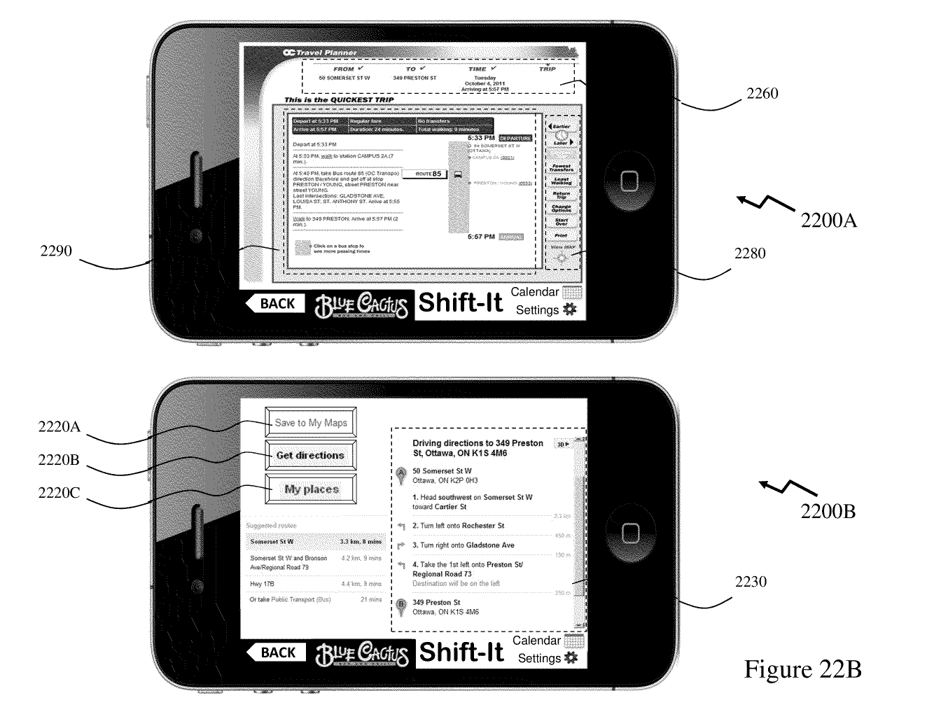

Now referring to FIG. 21 there is depicted a mapping screen presented to a user of a scheduling software application on their portable electronic device according to an embodiment of the invention. Within each display screen presented above in respect of FIGS. 17 through 20 there have been a constant pair of icons at the bottom of the screen, being “Map” and “Settings” which transfer the user to a mapping screen such as the one presented here in FIG. 22 or to a settings screen wherein the user can edit aspects of the settings for the scheduling software application. In windows without the calendar display such as presented in FIGS. 19 and 20 as well as here in FIG. 21 a calendar icon is presented allowing the user to switch to the calendar view, which may be FIG. 17 or 18 according to default settings established by the user or as installed initially.

Accordingly, the user is presented with a set of directions to an employer's location. As such an employee accepting shifts from other employers or working for an employment provider can establish the location of the employer for any particular shift if they are unfamiliar with them. Additionally, wherein an employer operates multiple locations an employee may have accepted a shift from the “TradeZone” at a location they have not previously worked at and seek directions. In addition to the directions two icons are presented to the user allowing them to select either an “Illustrated Map” or “Google Map” to be subsequently displayed to them. An “Illustrated Map” may for example be one extracted from the employer's website for guiding customers to their location or one provided by the employer solely for employees such as identifying employee parking/entrance which are different from the main customer areas. “Google Map” transfers the employer to an interactive Google map accessed by entering the employer location in a query to the Google map website, such as presented in FIG. 22A.

As displayed in FIG. 22A the user is presented with a Google map 2210 of the location of the employer relating to their shift in a map screen. At the top the display also presents two buttons, “Map” and “List” wherein the user can move between a map screen as shown in Google map 2200 and a list screen 2250 wherein the locations of the employer are listed. Selecting an arrow adjacent to a location in the list screen 2250 takes the user to a new Google map 2200 of that location. Accordingly, if a shift is available in the “TradeZone” at a location the user is unfamiliar with they can access the map screen and locate the location from the list and obtain a map allowing them for example to determine if they can get from one location to another in the time between two shifts on the same day or get to/from the location according to when their shift starts/ends. This being particularly important for younger employees etc who are without a vehicle and rely on public transport. Optionally, the user may be linked to websites of public transport which have search features. Accordingly the destination address is already populated with the employer's location, the start address is already populated with their home address, and the target arrival time is a predetermined offset from the start of the shift which may be edited by the employee, such as described below in respect of FIG. 22B.

FIG. 22B depicts a public transport display 2200A presented to a user of a scheduling software application on their portable electronic device based upon automatic population of the travel search on the public transport website based upon a shift and the employee's personal information according to an embodiment of the invention. Accordingly as shown in FIG. 22B details pane 2260 shows the start address (for example employee's home address unless modified in defaults of the application), end address (employee address), and arrival time (5:57 pm) based upon a shift start of 6:00 pm. Navigation pane 2280 from the public transport provider allows the journey details to be varied, such as minimizing walking, fewest transfers, etc. Trip pane 2290 shows the employee the specific details of the trip including whether there are transfers, which bus (in this instance) service to catch, from where to where.

Alternatively, through a default setting of the employee, rather than accessing public transport route information a direction display 2200B is displayed to the employee based upon information extracted from a map engine, such as Goggle, allowing the employee to obtain driving directions 2230 to the employer's location from their default starting address, e.g. home. Also presented are a series of buttons “Save to My Maps” 2220A, “Get Directions” 2220B, and “My Places” 2220C which allow the user to either save the map for subsequent retrieval, enter different information for the directions such as dropping off a friend on the way, and retrieving another default location for the directions, such as girlfriend's address. Optionally, the user's personal electronic device may communicate the employer's location to an in-vehicle navigation system when the user either triggers a feature within the scheduling software application or when the current time is within a predetermined range of the start time of a scheduled shift for the user.

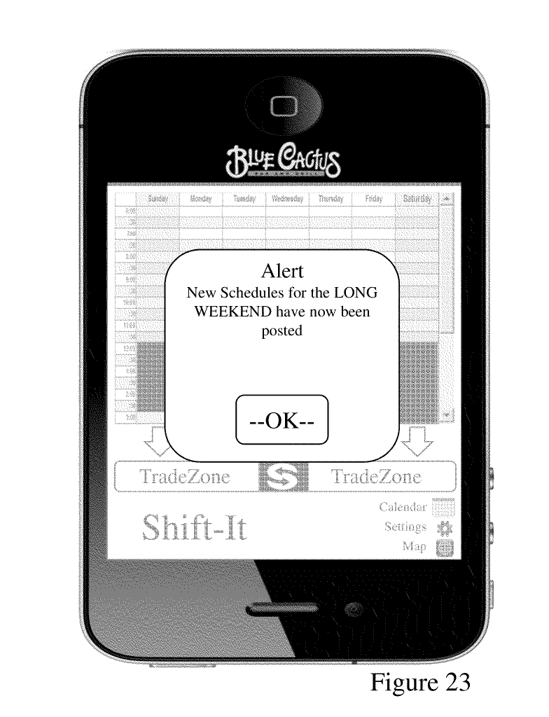

Referring to FIG. 23 there is depicted an alert screen presented to a user of a scheduling software application on their portable electronic device according to an embodiment of the invention wherein a new schedule or schedule amendment has been posted by the employer such that all employees are aware the new schedule or schedule amendment has been made. In this instance the employer has added the note “New Schedules for the LONG WEEKEND have now been posted” to make it clear what has been posted for employees. Such broadcast announcements to all employees of an employer may also be automatically generated when the employer completes for example a new roster or makes amendments to the schedule. Optionally, the alert screen may be provided only to those employees that have had a change made to their schedule. The “OK” button once clicked by the user communicates this back to the scheduling software system so that record of the acceptance of the notification is stored thereby removing the ability of an employee subsequently claiming not to be aware of a schedule change when they have selected the acceptance button.

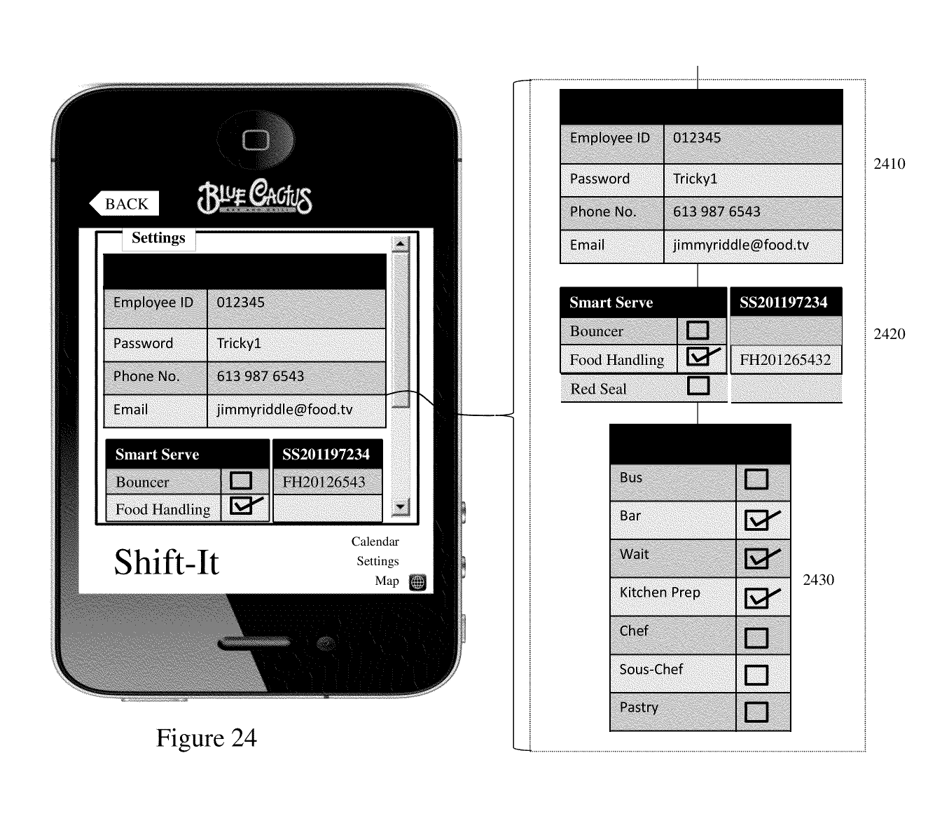

Now referring to FIG. 24 there is depicted a settings screen presented to a user of a scheduling software application on their portable electronic device according to an embodiment of the invention such as accessed by a user selecting the “Settings” icon on any of the preceding display screens discussed in respect of FIGS. 17 through 23. As such the user is presented with initial information, comprising personal details 2410 and certification details 2420. Also presented is a vertical scroll-bar allowing the user to scroll through the settings such as scrolling down to the job descriptions 2430 that shows what positions within an employer their certification details allow? Accordingly, if a new certification is added to certification details 2420 or a certification expires without being renewed then the job descriptions 2430 is updated to reflect the new positions they can work within or those that they are now not able to work. Optionally additional options and information may also be presented to the user through the settings screen such as allowing them to customize certain aspects of the displays, default settings for start location of travel, time between arriving at employer and starting shift, etc.

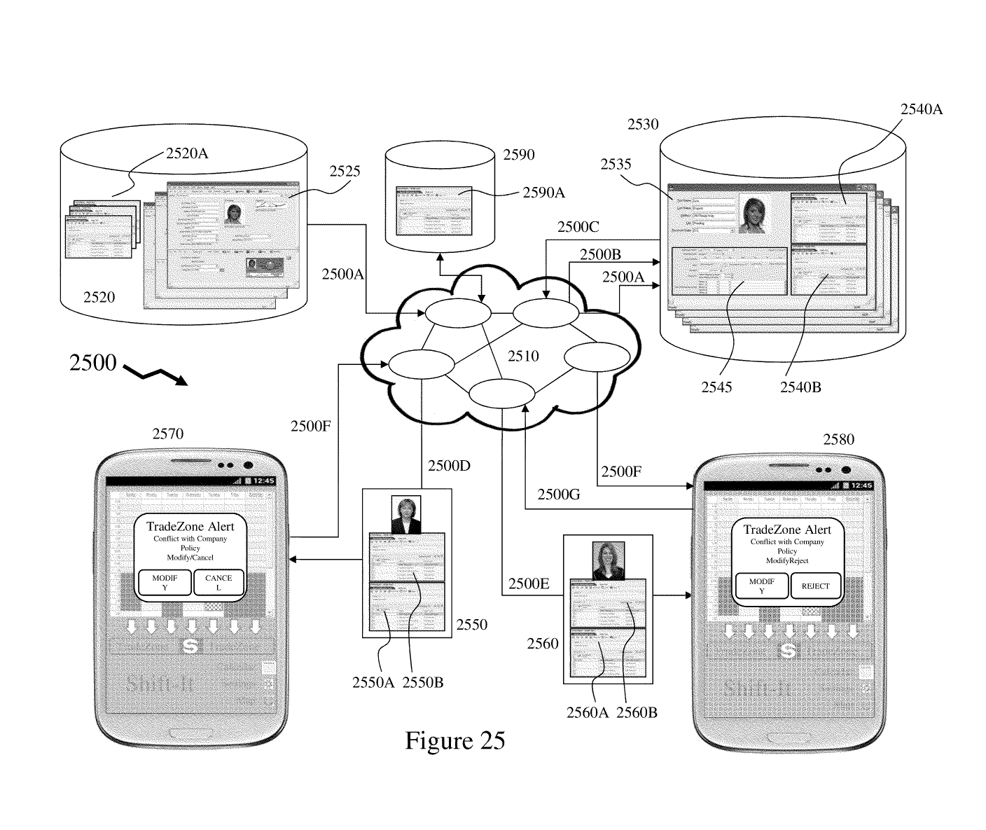

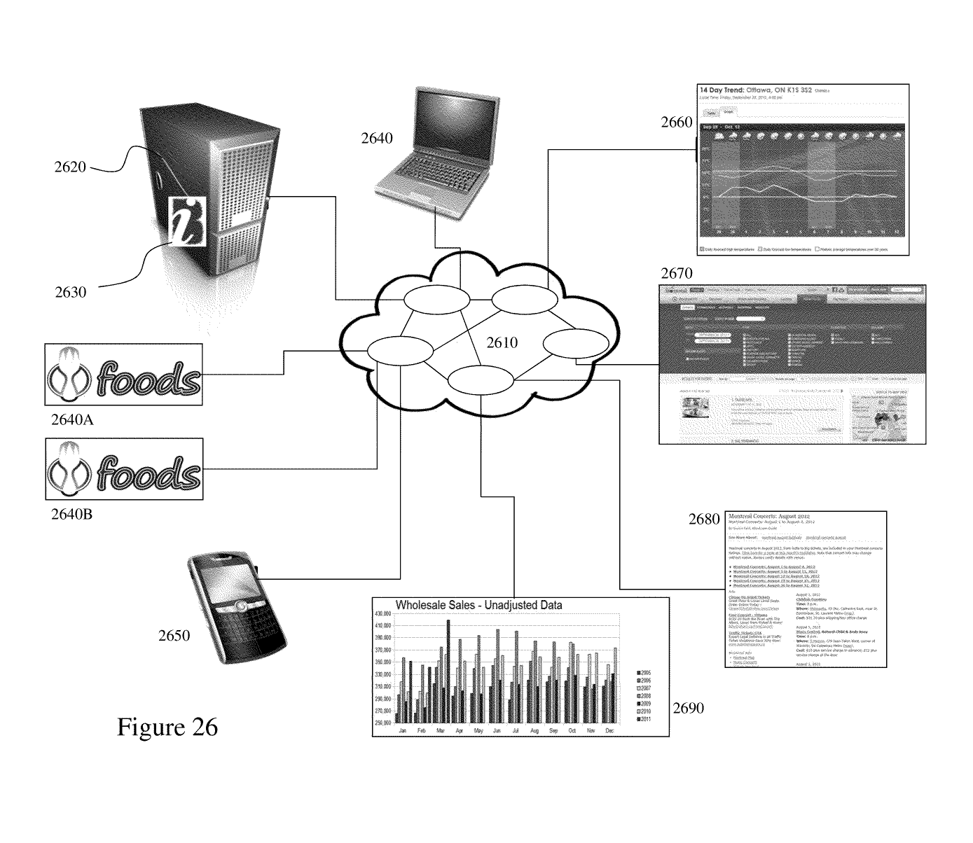

Now referring to FIG. 25 there is depicted an exemplary system and process flow 2500 for a scheduling software application invoking centralized and distributed rules in managing schedules according to an embodiment of the invention. Accordingly as depicted a first server 2520 containing employee records 2525 is in communication via a network 2510 with a second server 2530 executing a scheduling software system according to an embodiment of the invention comprising employee profiles 2535. Employee profile 2535 comprises a predetermined subset of the employee record 2525 together with employee financial data 2545 relating to pay rates, standard schedule etc, employer rule set 2540A, and employee rule set 2540B. Employer and employee rule sets 2540A and 2540B respectively relate to rules of the employer and employee respectively which are employed within centralized and distributed rules engines as described below. As depicted employer rule set 2540A is received by the scheduling software system from a third server 2590 in communication 2500B containing employer rules 2590A and employee rule sets 2540B are received from first server 2520 containing employee rules 2520A in communication 2500A together with the predetermined subset of the employee record 2525.

Also connected to network 2510 are first and second user PEDs 2570 and 2580 respectively associated with employees of the employer to whom the employer rule set 2540A relates and may be a sole organization executing the scheduling software system on second server 2530, a branch, office or subsidiary of an organization executing the scheduling software system or a subscriber to a service offering the scheduling software system for example. Accordingly the scheduling software system transmits rule set communications 2500C to the network 2510 such that first user PED 2570 receives first rule set 2550 comprising first employer rule set 2550A and first employee rule set 2550B as communication 2500D. Second user PED 2580 receives second rule set 2560 comprising second employer rule set 2550A and second employee rule set 2550B as communication 2500E.

Hence, if first user determines to make an adjustment to their schedule, such as described above in respect of embodiments of the invention, then as the employee makes the select shift adjustments the first employer rule set 2550A and first employee rule set 2550B upon their first user PED 2570 are exploited to determine whether one or both of the first employer rule set 2550A and first employee rule set 2550B are violated by the desired adjustment. If, so then the first user receives a message indicating the type of rule violation and presenting options to the first user. For example, as shown the first user is informed that the change conflicts with company policy and is given options, in this instance modify or cancel. Once a valid change has been made this is transmitted to the network 2510 as communication 2500F to the scheduling software system in execution upon the second server 2530 wherein it is then sent to the second user and the second user PED 2580 either upon a selection of the second user by the first user, their selection by the scheduling software system, or their own determination to accept a shift exchange. Such variants being described supra in respect of embodiments of the invention wherein the employer and employee rules allow for management of the employer's budget and manpower as well as ensuring trade union agreements, employee agreements, staff seniority, employee skill levels, and employee certifications for example are integrated into the employee scheduling process as well as the trading of shifts etc.

When received upon second user PED 2500G the scheduling software application will also apply second employer rule set 2560A and second employee rule set 2560B to activities and similarly if a rule violation is determined to exist from a desired adjustment to also provide a message indicating the type of rule violation and presenting options to the first user. Accordingly, activities relating to the shifts of employees of an employer may be bounded by rules established both by the employer and by the employees. These rules may include information relating to other aspects of the scheduling software system and/or application. The pushing of such rule processes to the user, as exemplified by first and second user PEDs 2570 and 2580 respectively allows for employees to be aware of rule based limits during their interaction with the scheduling software application and/or scheduling software system. Further in the event that communications with the central server are unavailable the employee(s) can still perform a variety of functions. It would be evident that the rules distributed/pushed to the employee from the centralized server may be a subset of the overall rules for the employer and/or employee.

Within the embodiments of the invention presented above employees employed by an organization may trade and/or auction shifts. Optionally the organization may establish rules or guidelines in respect of employees who perform such trades or auctions such that responsibility for the shift transfers with the shift to the new employee. In other instances the organization may maintain responsibility with the employee originally scheduled to execute the shift.

It would be evident to one skilled in the art that the scheduling software system according to embodiments of the invention may track the trade/auction activities of the employee or employees as well as having access to additional scheduling information derived from the external databases linked to the employee, including but not limited to, University or school, sports, and other employment. Accordingly, the scheduling software system may track the number of shifts the employee auctions or trades as well as what shifts they trade or auction. This information may be utilized by the scheduling software system including, for example, preventing the employee making further trades/auctions if a predetermined number of trades/auctions are made by the employee in a predetermined period, by adjusting scheduling to avoid shifts the employee has high frequency of trading/auctioning, by adjusting scheduling to favour shifts the employee has high frequency of accepting in trading/auctioning, and as part of an employee assessment.

Now referring to FIG. 26 there is depicted an exemplary system overview 2600 for a scheduling software application accessing distributed information resources with respect to managing schedules according to an embodiment of the invention. As depicted a server 2620 has in execution upon it a scheduling software system 2630 according to an embodiment of the invention relating to the scheduling and management of employee shifts at first and second establishments 2640A and 2640B wherein the scheduling software system 2630 is in communication with the first and second establishments 2640A and 2640B via network 2610. Management and employees may access the scheduling software system 2630 and/or scheduling software application on their FEDs 2640 and/or PEDs 2650. However, in contrast to embodiments of the invention described above the scheduling software system 2630 is in communication with one or more data repositories such as first to fourth repositories 2660 through 2690 respectively wherein data extracted from these is either employed directly within the scheduling software system 2630 or is accessible to the management/shift supervisor (or other individual) setting the employee work schedules in summary or full form. As depicted first to fourth repositories 2660 through 2690 respectively are weather forecast, first local schedule of events, second local schedule of events, and historical sales figures. It would be evident that other information resources may be included either by default, such as national or state weather services for example, or by the employer, such as a local sports arena schedule for example.

Accordingly, the scheduling software system 2630 may automatically optimize employee headcount, shift start times, shift end times, etc based upon historical and current data in order to provide the required employees at one or more locations in dependence upon this data but with a focus to minimizing labour cost for example. Other optimization criteria may be selected by the employer such as minimizing number of breaks, minimizing number of employees, and minimizing overtime for example.

It would be evident that the scheduling software system and/or application discussed supra in respect of embodiments of the invention provides a system that sends (from a central server) specific, personally tailored shift-trading information and limitations to the remote users of the applications, and uses those limits to broker shift trading with other application users. In embodiments of the invention these trade limitations can be automatically exchanged between multiple users, and used to govern which shifts can be selected and offered for trade from within the application, based on the multiple user schedules and imposed trading rules. In embodiments of the invention, all trading rules are respected, while not consuming data requests or connections with the central server. Effectively in some embodiments of the invention an entire shift trading transaction and associated rule checking is pushed to the network edge, and maintains the transactions in the cellular network for example, which will typically eliminate cellular-internet network latency issues, while respecting the central server rules base. After the completed transaction, the master schedule can be updated, requiring only one communication to the central server hosting the scheduling software system instead of multiple calls.

It would also be evident that such trading rules may initially limit the shifts available for trading to an employee based upon a first subset of the trading rules, e.g. required qualification(s), and then verify the trading shift request upon a second subset of the trading rules, e.g. total hours worked or overtime hours already scheduled.

It would also be apparent to one skilled in the art that the scheduling software system and scheduling software application in accessing remote databases may require usernames, passwords, and other information to retrieve the scheduling information. Optionally, this information may be stored in an encrypted format within the scheduling software system based upon information provided from the scheduling software application as authorized by the user. Alternatively, the data may be stored within the scheduling software application and retrieved by the scheduling software system as required or stored in secure encrypted format on a server remote to the scheduling software system and scheduling software application. It would be evident that the scheduling software system within the descriptions of embodiments of the invention has been described as being in execution upon a server, which may comprise one or more microprocessor based systems. However, it would be evident that said server may be a FED(s) and/or PED(s) according to the characteristics of the said device(s) and the scheduling software system.

According to another embodiment of the invention an employee utilizing the scheduling software application would have a personal information screen containing all the required information for an employer. If the employee transfers to another employer, or works for another employer for some shifts, then they can transfer all this personal information to the new employer automatically by selecting the appropriate icon within the scheduling software application. If the user's portable electronic device is within communication range of the scheduling software system of the new employer their information is automatically transferred to the new employer's scheduling software system. Optionally, the employee when out of range of an employer's scheduling software system they enter the employer's name into the scheduling software application prior to transferring and the information is routed to the employers scheduling software system via the software provider. The above-described embodiments of the present invention are intended to be examples only. Alterations, modifications and variations may be effected to the particular embodiments by those of skill in the art without departing from the scope of the invention, which is defined solely by the claims appended hereto.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing a portable electronic device associated to an individual comprising a memory and microprocessor and supporting wireless communications according to a first predetermined standard;
providing a computer comprising a memory and microprocessor and supporting communications to a network;
generating on the computer a schedule relating to an organization comprising a plurality of shifts, each shift associated with an employee of a plurality of employees and a location relating to the organization, wherein one of the plurality of employees is the individual;
verifying execution of a shift in the schedule relating to the individual based upon establishing wireless communications between the portable electronic device and wireless infrastructure operating according to the first predetermined standard associated with the location relating to the shift.

2. The method according to claim 1 wherein,
providing the portable electronic device further comprises the portable electronic device supporting wireless communications according to a second predetermined standard; and
data relating to a shift in the schedule relating to the individual is provided to the user via the portable electronic device via wireless communications with the network according to the second predetermined standard wherein the data is provided to the network from the computer.

3. The method according to claim 1 wherein,
generating the schedule includes a step of accessing a remote database to the computer, the remote database containing at least one of scheduling information relating to the individual, regulatory information relating to the organization, information relating to certification of the individual, and regulatory information relating to the employee's work with the organization.

4. The method according to claim 3 wherein,
at least one of the remote database requires credential information to be provided in order to retrieve the scheduling information wherein the credential information is at least one of stored within the memory of the portable electronic device, stored within the memory of the computer, and stored within a memory of a server connected to the network associated with the scheduling application on the computer.

4. The method according to claim 1 further comprising;
providing information to a plurality of other employees relating to a shift associated with the employee that the employee wishes to at least one of trade for another shift with one of the plurality of other employees and auction in an auctioning process with the plurality of employees.

5. The method according to claim 5 wherein,
when the at least one of comprises an auction the information may include an incentive for another employee of the plurality of employees to accept the shift being auctioned.

6. The method according to claim 1 wherein,
providing the information comprises providing the information as a post to a web based application wherein any employee associated with at least one of a group and an identity of a user of the web based application receives the information on their own portable electronic devices.

7. A method comprising:
providing a portable electronic device associated to an individual comprising a memory and microprocessor and supporting wireless communications according to a first predetermined standard;
providing a computer comprising a memory and microprocessor and supporting communications to a network;
generating on the computer a schedule relating to an organization comprising a plurality of shifts, each shift associated with an employee of a plurality of employees and a location relating to the organization, wherein one of the plurality of employees is the individual;
verifying execution of a shift in the schedule relating to the individual based upon establishing the employee's location relative to the location relating to the shift.

8. The method according to claim 7 wherein,
establishing the employee's location comprises at least one of obtaining data from a global positioning system, triangulating the portable electronic device position with respect to infrastructure providing wireless communications according to the first predetermined standard, establishing near-field communications between the portable electronic device and a point-of-sale terminal, and based upon a characteristic of communications between the portable electronic device and network infrastructure providing wireless communications according to the first predetermined standard.

9. The method according to claim 7 wherein,
generating the schedule includes a step of accessing a remote database to the computer, the remote database containing at least one of scheduling information relating to the individual, regulatory information relating to the organization, information relating to certification of the individual, and regulatory information relating to the employee's work with the organization.

10. The method according to claim 9 wherein,
the remote database is accessible to at least one of the portable electronic device and computer and is at least one of a web page, a calendar stored as part of a website, a calendar stored as part of a social network application, and a schedule of shifts for employees stored on a computer of another organization.

11. A method comprising:
providing a first portable electronic device associated to an individual comprising a memory and microprocessor and supporting wireless communications according to a first predetermined standard to a network;
receiving on the first portable electronic device first schedule data relating to a schedule of an organization comprising at least a shift of a plurality of shifts, each shift associated with an employee of a plurality of employees and a location relating to the organization, wherein one of the plurality of employees is the individual;
receiving on the first portable electronic device a trade shift request from the individual relating to a shift within their schedule with another individual having a shift within their schedule that the individual wishes to trade for their shift;
verifying on the first portable electronic device whether the trade shift request complies with at least a first rule of a plurality of first rules stored within a rule database on the portable electronic device; and
transmitting trade shift request data to the another individual relating to the trade shift request in dependence upon at least the determination of the verification.

12. The method according to claim 11 wherein,
the transmission of the trade shift request data is made at least one of:
directly between the first portable electronic device of the individual and a second portable electronic device associated with the another individual; and
indirectly via a remote server connected to the network storing a master schedule relating to the employees of the organization such that the trade shift request may be flagged within the master schedule as pending based upon the transmission.

12. The method according to claim 11 wherein,
the first rule of the plurality of rules relate to at least one of the organization and the individual.

13. The method according to claim 11 further comprising:
receiving the data on the second portable electronic device relating to the transmitted trade shift request data when the determination of the verification is that the trade shift request is allowable;
verifying on the second portable electronic device whether the trade shift request complies with at least a second rule of a plurality of second rules stored within a rule database on the second portable electronic device; and
determining whether to notify the another individual of the trade shift request and transmitting a first rejection message to the individual in dependence upon at least the verification.

14. The method according to claim 11 wherein,
the first rule of the plurality of rules relates to at least one of maximum hours, overtime policy, labour cost, certification, and qualification.

15. A method comprising:
providing a computer comprising a memory and microprocessor and supporting communications to a network;
storing on the computer schedule data relating to a schedule of an organization comprising at least a shift of a plurality of shifts, each shift associated with an employee of a plurality of employees and a location relating to the organization;
storing on the computer at least a first rule of a plurality of first rules;
extracting a predetermined portion of the schedule data relating to schedule relating to a predetermined portion of the plurality of shifts relating to the employee of the plurality of employees;
extracting a predetermined portion of the plurality of first rules, the predetermined portion determined in dependence upon at least the predetermined portion of the plurality of shifts relating to the employee of the plurality of employees; and
transmitting the predetermined portion of the schedule data and the predetermined portion of the plurality of first rules to an electronic device associated with the employee of the plurality of employees.

16. The method according to claim 15 further comprising:
providing the employee of the plurality of employees with the ability to initiate a trade shift request, the trade shift request relating to a shift within the predetermined portion of the schedule data;
providing on the electronic device a verification process for determining whether the trade shift request complies with at least a predetermined portion of rules stored within a rule database on the portable electronic device, the rule database comprising at least the predetermined portion of the plurality of first rules;
providing on the electronic device a transmission process for transmitting a first message relating to the trade shift request to another individual when the determination of the verification is positive and providing a second message upon the electronic device for the employee of the plurality of employees when the determination of the verification is negative.

17. The method according to claim 16 wherein,
providing the employee of the plurality of employees with the ability to initiate a trade shift request further comprises providing to the employee of the plurality of employees information relating to available shifts, the available shifts determined in dependence upon filtering all shifts relating to an employer of a plurality of employers of the employee of the plurality of employees with a subset of the predetermined portion of the plurality of first rules.

18. The method according to claim 15 wherein
transmitting the predetermined portions of the schedule data and the plurality of first rules further comprises transmitting to the electronic device a plurality of second rules, the plurality of second rules associated with at least an employer of a plurality of employers of the employee of the plurality of employees.
